(19) United States
(12) Patent Application Publication
(10) Pub. No.: US 2026/0125298 A1
(43) Pub. Date: May 7, 2026

(54) ELECTRO-DIALYTIC CRYSTALLIZERS AND METHODS OF USE THEREOF

(71) Applicant: VANDERBILT UNIVERSITY, Nashville, TN (US)

(72) Inventor: Shihong LIN, Nashville, TN (US)

(21) Appl. No.: 19/117,878

(22) PCT Filed: Oct. 6, 2023
(86) PCT No.: PCT/US2023/034641

§ 371 Date: Apr. 2, 2025

Related U.S. Application Data
(60) Provisional application No. 63/416,032, filed on Oct. 14, 2022.
(60) Provisional application No. 63/433,528, filed on Dec. 19, 2022.

(51) Int. Cl. C02F 1/469; B01D 9/00; C02F 1/00; C02F 1/44; C02F 1/52; C02F 9/00; C02F 103/08

(52) U.S. Cl. CPC C02F 1/4693; B01D 9/004; B01D 9/005; B01D 9/0063; C02F 1/001; C02F 1/441; C02F 1/444; C02F 9/00; C02F 2001/5218; C02F 2103/08

(57) ABSTRACT

Disclosed herein are electro-dialytic crystallizers and methods of use thereof. For example, described herein are electro-dialytic crystallizer systems comprising an electro-dialysis module and a crystallizer module in liquid communication with the electrodialysis module. The electrodialysis module is configured to receive an aqueous feedwater solution and form a diluate stream and a brine stream, the aqueous feedwater solution comprising an ionic component, the diluate stream having a lower concentration of the ionic component relative to the aqueous feedwater solution, and the brine stream having a higher concentration of the ionic component relative to the aqueous feedwater solution. The crystallizer module is configured to receive the brine stream and form crystals comprising the ionic component and a supernatant. Also disclosed herein are methods of use of any of the systems disclosed herein, for example using the system to treat the aqueous feedwater solution.

WO

### CROSS-REFERENCE TO RELATED APPLICATIONS

This application claims the benefit of priority to U.S. Provisional Application 63/416,032 filed Oct. 14, 2022 and U.S. Provisional Application 63/433,528 filed Dec. 19, 2022, each of which is hereby incorporated herein by reference in its entirety.

### STATEMENT OF GOVERNMENT SUPPORT

This invention was made with government support under grant/contract number DE-FOA-0001905 awarded by the US Department of Energy. The government has certain rights in the invention.

### BACKGROUND

The management of hazardous high-salinity brines represents a prominent environmental challenge to water sustainability. A large volume of highly saline brine is generated from the energy, mining, and desalination industries. Current brine management commonly relies on evaporation ponds or injection into deep subterranean formations, which are plagued with the concerns of induced seismicity, negative impacts on groundwater, and the removal of accessible water from the hydrologic cycle. Therefore, zero liquid discharge (ZLD) is the preferred brine management approach and a key component of water circularity. However, achieving cost-effective zero liquid discharge is technically challenging due to the very high salinity (i.e., total dissolved solids, or TDS) of the brines. Improved devices and methods for brine management are needed. The devices, systems, and methods disclosed herein address these and other needs.

### SUMMARY

In accordance with the purposes of the disclosed devices, methods, and systems as embodied and broadly described herein, the disclosed subject matter relates to electro-dialytic crystallizers and methods of use thereof.

For example, described herein are electro-dialytic crystallizer systems comprising an electrodialysis module and a crystallizer module in liquid communication with the electrodialysis module. The electrodialysis module is configured to receive an aqueous feedwater solution and form a diluate stream and a brine stream, the aqueous feedwater solution comprising an ionic component (e.g., one or more ionic components), the diluate stream having a lower concentration of the ionic component relative to the aqueous feedwater solution, and the brine stream having a higher concentration of the ionic component relative to the aqueous feedwater solution. The electrodialysis module comprises: a feed channel (e.g., one or more feed channels) configured to receive the aqueous feedwater solution; an ion exchange membrane (e.g., one or more ion exchange membranes); a brine channel (e.g., one or more brine channels); and a voltage source. The ion exchange membrane forms a boundary between the feed channel and the brine channel. The ion exchange membrane is in electrochemical and liquid communication with both the feed channel and the brine channel. The voltage source is configured to apply an electric field across the feed channel, ion exchange membrane, and brine channel, such that (when the electric field is applied) the ionic component migrates from the feed channel, across the ion exchange membrane, and into the brine channel, thereby forming the diluate stream in the feed channel and the brine stream in the brine channel. The crystallizer module is configured to receive the brine stream from the brine channel and form crystals comprising the ionic component and a supernatant.

In some examples, the ion exchange membrane comprises an anion exchange membrane, a cation exchange membrane, or a combination thereof.

In some examples, the ion exchange membrane is selective for a target ion.

In some examples, the electrodialysis module comprises a first feed channel, a second feed channel, a first ion exchange membrane, and a second exchange membrane, wherein the first exchange membrane forms a boundary between the first feed channel and the brine channel, and the second ion exchange membrane forms a boundary between the second feed channel and the brine channel. In some examples, the first ion exchange membrane is a cation exchange membrane and/or the second ion exchange membrane is an anion exchange membrane.

In some examples, the electrodialysis module comprises a first feed channel, a second feed channel, a first brine channel, a second brine channel, a first ion exchange membrane, a second exchange membrane, and a third ion exchange membrane, wherein the first exchange membrane forms a boundary between the first feed channel and the first brine channel, the second ion exchange membrane forms a boundary between the second feed channel and the first brine channel, and the third ion exchange membrane forms a boundary between the second feed channel and the second brine channel.

In some examples, the system further comprises a filtration module in liquid communication with the crystallizer module, wherein the filtration module is configured to separate the crystals from the supernatant. In some examples, the filtration module is further in liquid communication with the electrodialysis module.

In some examples, the brine channel is further configured to receive the supernatant from the crystallizer module and/or the filtration module.

In some examples, the crystallizer module is further configured to receive a reactant, for example that reacts (e.g., with the target ion) to form crystals within the crystallizer module.

In some examples, the system further comprises a reverse osmosis module in liquid communication with the electrodialysis module, wherein the reverse osmosis module is configured to receive the diluate stream from the feed channel and subject the diluate stream to reverse osmosis to form a water stream and an effluent stream. In some examples, the system further comprises a collection container in liquid communication with the reverse osmosis module, the collection container being configured to receive and store the water stream from the reverse osmosis module. In some examples, the feed channel is further configured to receive the effluent stream from the reverse osmosis module.

In some examples, the ionic component comprises a salt, an electrolyte, or a combination thereof. In some examples, the ionic component comprises an alkali metal salt, a sulfate, a nitrate, a halide, or a combination thereof. In some examples, the ionic component comprises a potassium salt, a sodium salt, a sulfate, a nitrate, a chloride, or a combination thereof. In some examples, the ionic component comprises Na₂SO₄, K₂SO₄, KNO₃, NaCl, KCl, or a combination thereof. In some examples, the ionic component comprises Na₂SO₄, K₂SO₄, KNO₃, or a combination thereof.

In some examples, the system is a zero liquid discharge system.

In some examples, the aqueous feedwater solution comprises a salt solution, produced water (e.g., from mining, fracking, oil recovery), brine, or a combination thereof. In some examples, the aqueous feedwater solution comprises brine resulting from the power industry, chemical industry, food industry, oil and gas industry (e.g., hydraulic fracturing), desalination industry (e.g., inland brackish water desalination), mining industry, or a combination thereof.

In some examples, the aqueous feedwater solution has a total dissolved solids content of from greater than 0 g/L to 250 g/L. In some examples, the aqueous feedwater solution has a total dissolved solids content of 30 g/L or more, 50 g/L or more, 75 g/L or more, 100 g/L or more, or 200 g/L or more.

In some examples, the total dissolved solids of the diluate stream is less than that of the aqueous feedwater solution.

In some examples, the total dissolved solids of brine stream is greater than that of the aqueous feedwater solution.

In some examples, the water stream is substantially free of dissolved solids (e.g., has a total dissolved solids content if substantially 0).

Also disclosed herein are methods of use of any of the systems disclosed herein. In some examples, the methods comprise using the system to treat the aqueous feedwater solution.

Additional advantages of the disclosed devices, systems, and methods will be set forth in part in the description which follows, and in part will be obvious from the description. The advantages of the disclosed devices, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Schematic illustration of an example electro-dialytic crystallizer system 100 as disclosed herein according to one implementation.

FIG. 2. Schematic illustration of an example portion of an electrodialysis module as disclosed herein according to one implementation.

FIG. 3. Schematic illustration of an example portion of an electrodialysis module as disclosed herein according to one implementation.

FIG. 4. Schematic illustration of an example electro-dialytic crystallizer system 100 as disclosed herein according to one implementation.

FIG. 5. Schematic illustration of an example electro-dialytic crystallizer system 100 as disclosed herein according to one implementation.

FIG. 6. Schematic illustration of an example electro-dialytic crystallizer system 100 as disclosed herein according to one implementation.

FIG. 7A. Schematic illustration of an electro-dialytic crystallizer which combines an electrodialysis system and a crystal collector. The oversaturated brine is recirculated through the brine channels and the external crystal collector based on temperature change or filtration mechanisms. Temperature control may be installed but is not shown in the schematic.

FIG. 7B. Illustration of the mechanism of crystal formation in an electro-dialytic crystallizer: anions and cations transport through an anion exchange membrane (AEM) and a cation exchange membrane (CEM), respectively, under the applied electric field, to the oversaturated brine, where they precipitate to become the crystals.

FIG. 8A. Schematic of an electro-dialytic crystallizer/reverse osmosis hybrid treatment train for zero liquid discharge. The total dissolved solids of different streams are denoted as Cₓ.

FIG. 8B. Schematic of electrodialysis system.

FIG. 9A-FIG. 9D. Electro-dialytic crystallizer experimental data collected from experiments using Na₂SO₄ with four different current densities. The open and solid blue circles represent brine and diluate conductivities, respectively; the red squares represent cell voltage; and the green triangles represent TSS.

FIG. 10. TSS of the brine stream as a function of time for different current densities.

FIG. 11. An example device as described herein.

FIG. 12. A simplified schematic of the electro-dialytic crystallizer process coupled with reverse osmosis for zero liquid discharge without thermal evaporation.

FIG. 13A. Schematic illustration of the concept for electro-dialytic crystallization: ions in the diluate streams are pulled to the recirculated brine loop where the solute concentration may exceed the saturation limit, resulting in precipitation of salt crystals.

FIG. 13B. Representative concentration profiles of counter ions across an ion exchange membrane (either cation exchange membranes or anion exchange membranes) for electro-dialytic crystallization (EDC) vs. electrodialysis (ED). The profiles are only depicted for comparing the relative levels of concentrations (not to scale).

FIG. 13C. Membrane potential as a function of brine and diluate salinities following the equation shown in the figure. The plot is generated using NaCl (as an example) and applying the approximation of ideal solution throughout the range of salinity. While the value of Vₘₑₘ may change with more accurate evaluation (e.g., using activities) and with other salts, the comparison of Vₘₑₘ between electrodialysis (ED) and electro-dialytic crystallization (EDC) should be generally valid.

FIG. 14A. Schematic of the experimental setup for electro-dialytic crystallization experiments, integrating an electrodialysis cell, a crystallizer, and a microfiltration (MF) unit.

FIG. 14B. Comparison between continuous mode, where crystallization occurs within the electro-dialytic crystallization system, and batch mode, where crystallization occurs external to the electro-dialytic crystallization system. In continuous mode, the brine temperature in the crystallizer was maintained at 18° C. and crystals were in-situ produced and measured; while in batch mode, the electro-dialytic crystallization system was operated at room temperature and crystals were produced in an 18° C. water bath and then measured. The electrodialysis cell comprises 2 pairs of the standard ion exchange membranes.

FIG. 14C. Total suspended solids in both g L⁻¹ (left) and mole L⁻¹ (right) as a function of operation time with different operating modes (FIG. 14B) and current densities (20, 40, and 60 mA cm⁻²) for electro-dialytic crystallization of Na₂SO₄. The initial diluate was 2 L of 6 wt. % (63.8 g L⁻¹) Na₂SO₄, while the initial brine was 1 L of saturated Na₂SO₄ (192 g L⁻¹, corresponding to Na₂SO₄ solubility at 20° C.).

FIG. 15A-FIG. 15C. The variation of crystal sizes produced by electro-dialytic crystallization under different current densities. Optical crystal images after 180-min operation (top) and particle size distributions of crystals at 60 and 180 minutes (bottom) for continuous mode with current densities of (FIG. 15A) 20 mA cm⁻², (FIG. 15B) 40 mA cm⁻², and (FIG. 15C) 60 mA cm⁻².

FIG. 15D. Summary of average particle sizes and standard deviations produced by electro-dialytic crystallization at different operation times and current densities.

FIG. 15E. An example of crystals collected from batch mode at a current density of 40 mA cm⁻². The size of crystals collected from batch mode does not seem to depend on current density.

FIG. 16A. Total suspended solids (TSS) production rates of Na₂SO₄, K₂SO₄ and KNO₃ with continuous and batch modes. The electrodialysis cell configured with 5 pairs of the standard ion exchange membranes. The applied current density was 40 mA cm⁻². The initial diluate was 4 L of 0.6 M of each salt. The initial brine was 1 L of saturated solution of the respective salt (at 20° C.).

FIG. 16B. Theoretical brine concentration, i.e., total dissolved solids plus total suspended solids (if any), for five different salts. The operating conditions are the same as those for FIG. 16A.

FIG. 16C. Schematic illustration of salt crystallization mechanism in the electro-dialytic crystallization system.

FIG. 16D. Molar ratio of salt to water as calculated from the salt solubility at 18° C. (x axis) as compared to the ratio of salt flux to water flux at continuous mode (y axis). Blue rhombuses represent successful crystallization whereas red circles represent unsuccessful crystallization.

FIG. 16E. Theoretical brine concentration for NaCl and KCl as a function of operation time with low-water-uptake ion exchange membranes and different operating conditions.

FIG. 16F. Total suspended solids for NaCl and KCl as a function of operation time with low-water-uptake ion exchange membranes and different operating conditions.

FIG. 17A. The energy consumption and total efficiency of salt electromigration-crystallization in electro-dialytic crystallization system. Data was collected from Na₂SO₄ crystallization experiments of FIG. 14A-FIG. 14C at continuous mode.

FIG. 17B. Schematic diagram of the integrated electro-dialytic crystallization-reverse osmosis system. The salt rejection of the reverse osmosis unit is assumed to be 100% and salt crystals are produced in crystal collector (CC).

FIG. 17C. The energy consumption of electro-dialytic crystallization, reverse osmosis, and the integration process with varied salt rejections in the electrodialysis unit. The crystal yield efficiency is assumed to be 40%, 50% and 60%, separately; the feed solution of the system is 6 wt % Na₂SO₄ and the applied current density is 20 mA cm⁻².

FIG. 17D. The energy consumption of electro-dialytic crystallization, reverse osmosis, and the integration process with varied feed solution salinities. The crystal yield efficiency is assumed to be 40%, 50% and 60%, separately; the salt rejection in the electrodialysis unit is 60% and the applied current density is 20 mA cm⁻².

FIG. 18. Schematic of an experimental setup for selective electro-dialytic crystallization experiments, integrating an electrodialysis (ED) cell including a target ion selective ion exchange membrane (IEM), a crystallizer, and a microfiltration (MF) and/or an ultrafiltration (UF) unit.

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Described herein are electro-dialytic crystallizer devices and methods of use thereof. The electro-dialytic crystallizer devices can, for example, be used for wastewater treatment. The devices and systems described herein can for example be used for water processing, such as for treating industrial brine. The devices and systems described herein can for example be used for production of mineral crystals from brine.

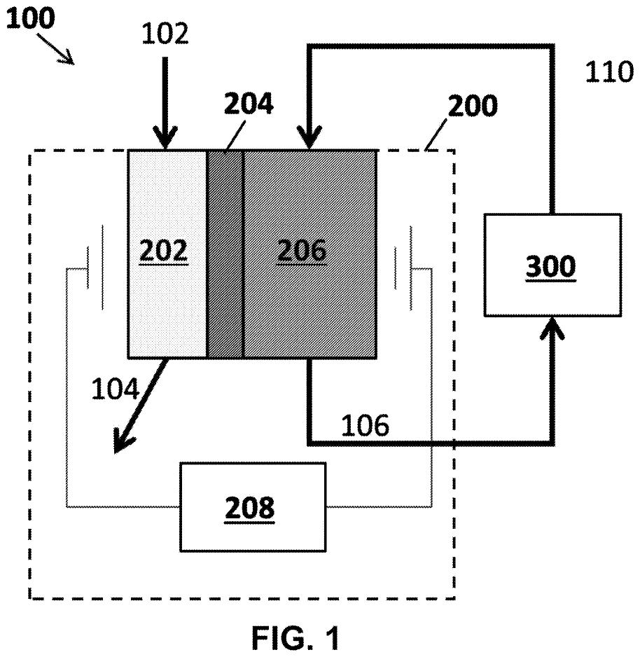

Referring now to FIG. 1, disclosed herein is an electro-dialytic crystallizer system 100 comprising. an electrodialysis module 200; and a crystallizer module 300 in liquid communication with the electrodialysis module 200. The electrodialysis module 200 is configured to receive an aqueous feedwater solution 102 and form a diluate stream 104 and a brine stream 106, the aqueous feedwater solution 102 comprising an ionic component (e.g., one or more ionic components), the diluate stream 104 having a lower concentration of the ionic component relative to the aqueous feedwater solution 102, and the brine stream 106 having a higher concentration of the ionic component relative to the aqueous feedwater solution 102. The aqueous feedwater solution 102, diluate stream 104, brine stream 106 are each independently a liquid.

The electrodialysis module 200 comprises: a feed channel 202 (e.g., one or more feed channels 202) configured to receive the aqueous feedwater solution 102; an ion exchange membrane 204 (e.g., one or more ion exchange membranes 204); a brine channel 206 (e.g., one or more brine channels 206); and a voltage source 208. The feed channel 202 and the brine channel 206 are each adjacent to the ion exchange membrane 204. The ion exchange membrane 204 forms a boundary between the feed channel 202 and the brine channel 206. The ion exchange membrane 204 is in electrochemical and liquid communication with both the feed channel 202 and the brine channel 206. The voltage source 208 is configured to apply an electric field across the feed channel 202, ion exchange membrane 204, and brine channel 206, such that (when the electric field is applied) the ionic component migrates from the feed channel 202, across the ion exchange membrane 204, and into the brine channel 206, thereby forming the diluate stream 104 in the feed channel 202 and the brine stream 106 in the brine channel 206.

The crystallizer module 300 is configured to receive the brine stream 106 from the brine channel 206 and form crystals comprising the ionic component and a supernatant 110. In some examples, the ionic component has a solubility limit in the brine stream 106, and the concentration of the ionic component in the brine stream 106 is greater than or equal to the solubility limit. In some examples, the crystallizer module 300 comprises a tank (e.g., a stirred tank) with temperature control. For example, the temperature of the crystallizer module 300 can be selected to form crystals of the ionic component.

The ion exchange membrane 204 can comprise any suitable ion exchange membrane, such as those known in the art. In some examples, the ion exchange membrane 204 comprises an anion exchange membrane, a cation exchange membrane, or a combination thereof. In some examples, the electrodialysis module comprises a plurality of ion exchange membrane pairs, each pair comprising a cation exchange membrane and an anion exchange membrane.

In some examples, the ion exchange membrane 204 can be selective for a target ion.

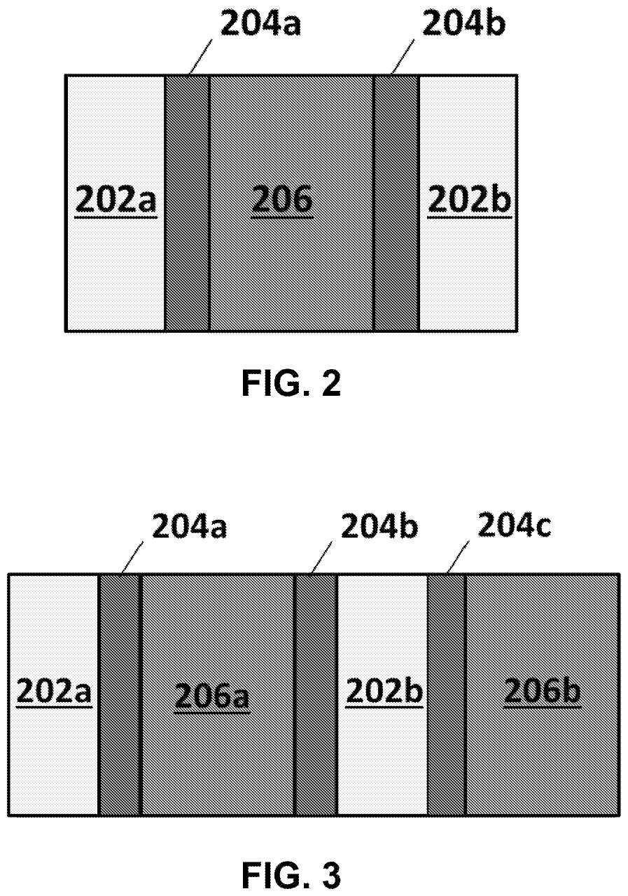

Referring now to FIG. 2, in some examples, the electrodialysis module 200 comprises a first feed channel 202a, a second feed channel 202b, a first ion exchange membrane 204a, and a second exchange membrane 204b, wherein the first exchange membrane 204a forms a boundary between the first feed channel 202a and the brine channel 206, and the second ion exchange membrane 204b forms a boundary between the second feed channel 202b and the brine channel 206. In some examples, the first ion exchange membrane 204a is a cation exchange membrane and/or the second ion exchange membrane 204b is an anion exchange membrane.

Referring now to FIG. 3, in some examples, the electrodialysis module 200 comprises a first feed channel 202a, a second feed channel 202b, a first brine channel 206a, a second brine channel 206b, a first ion exchange membrane 204a, a second exchange membrane 204b, and a third ion exchange membrane 204c, wherein the first exchange membrane 204a forms a boundary between the first feed channel 202a and the first brine channel 206a, the second ion exchange membrane 204b forms a boundary between the second feed channel 202b and the first brine channel 206a, and the third ion exchange membrane 204c forms a boundary between the second feed channel 202b and the second brine channel 206b.

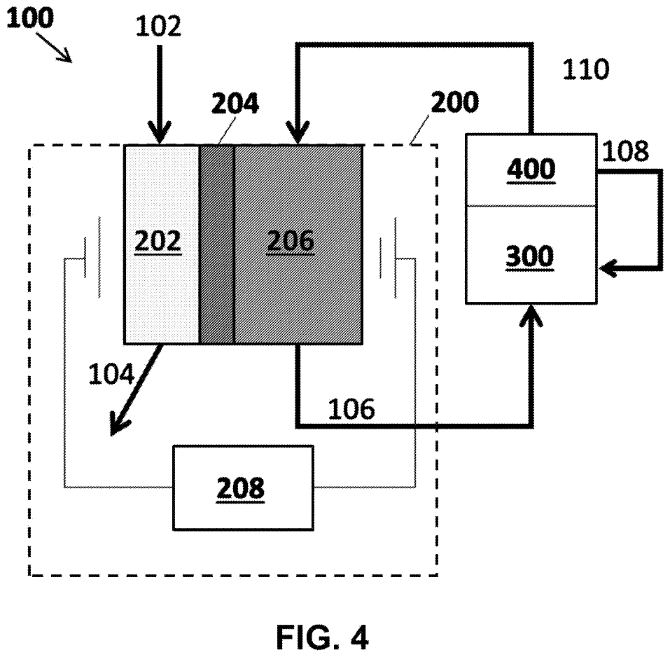

Referring now to FIG. 4, in some examples, the system 100 further comprises a filtration module 400 in liquid communication with the crystallizer module 300. The filtration module 400 is configured to separate the crystals from the supernatant 110. In some examples, the filtration module 400 is further in liquid communication with the electrodialysis module 200.

In some examples, the brine channel 206 is further configured to receive the supernatant 110 from the crystallizer module 300 and/or the filtration module 400.

In some examples, the crystallizer module 300 is further configured to receive a retentate stream 108 from the filtration module.

In some examples, the crystallizer module 300 is further configured to receive a reactant, for example that reacts (e.g., with the target ion) to form crystals within the crystallizer module 300.

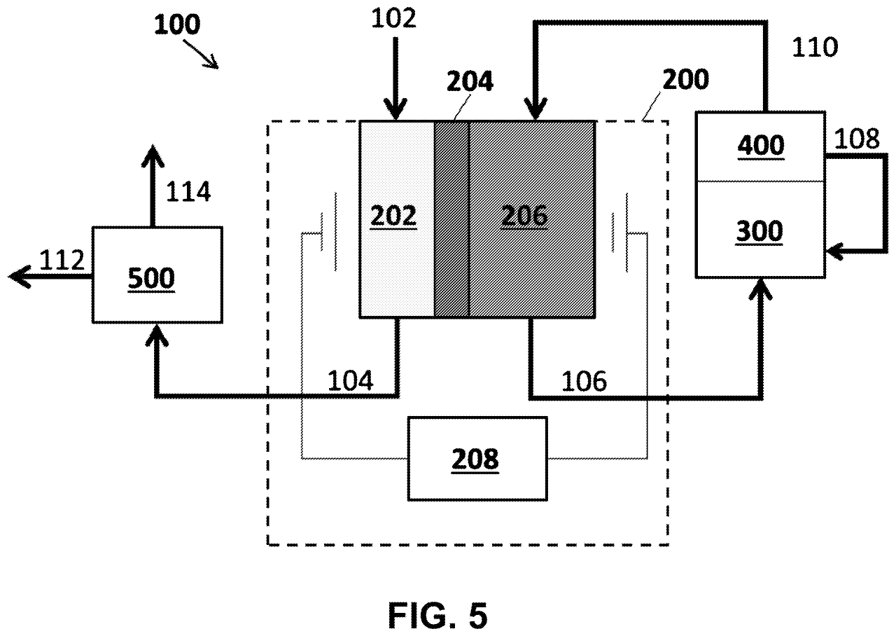

Referring now to FIG. 5, in some examples, the system 100 further comprises a reverse osmosis module 500 in liquid communication with the electrodialysis module 200. The reverse osmosis module is configured to receive the diluate stream 104 from the feed channel 202 and subject the diluate stream 104 to reverse osmosis to form a water stream 112 and an effluent stream 114.

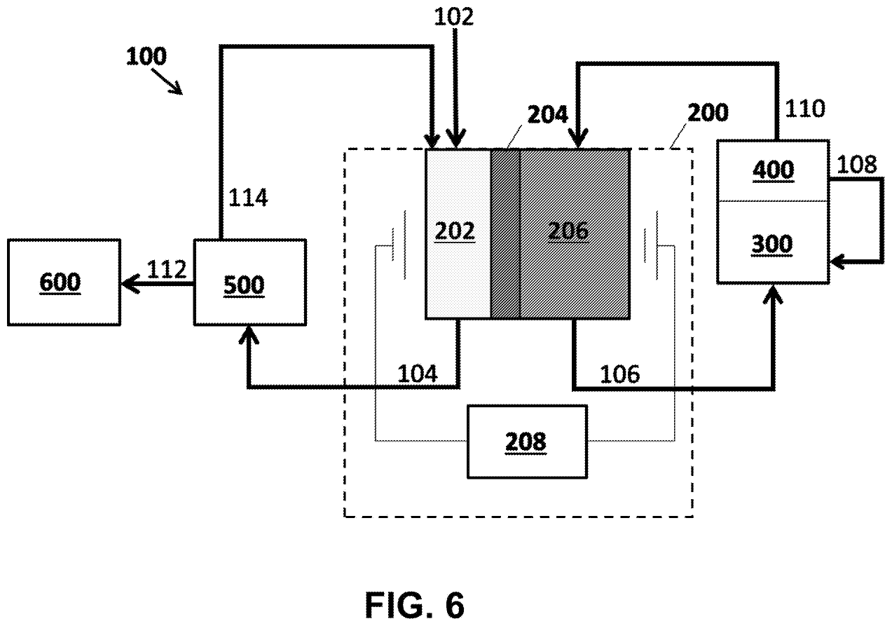

Referring now to FIG. 6, in some examples, the system 100 further comprises a collection container 600 in liquid communication with the reverse osmosis module 500, the collection container 600 being configured to receive and store the water stream 112 from the reverse osmosis module 500.

In some examples, the feed channel 202 is further configured to receive the effluent stream 114 from the reverse osmosis module.

In some examples, the system is a zero liquid discharge system.

In some examples, the ionic component comprises a salt, an electrolyte, or a combination thereof. In some examples, the ionic component comprises an alkali metal salt, a sulfate, a nitrate, a halide, or a combination thereof. In some examples, the ionic component comprises a potassium salt, a sodium salt, a sulfate, a nitrate, a chloride, or a combination thereof. In some examples, the ionic component comprises Na₂SO₄, K₂SO₄, KNO₃, NaCl, KCl, or a combination thereof. In some examples, the ionic component comprises Na₂SO₄, K₂SO₄, KNO₃, or a combination thereof.

In some examples, the aqueous feedwater solution 102 comprises a salt solution, produced water (e.g., from mining, fracking, oil recovery), brine, or a combination thereof.

In some examples, the aqueous feedwater solution 102 comprises brine resulting from the power industry, chemical industry, food industry, oil and gas industry (e.g., hydraulic fracturing), desalination industry (e.g., inland brackish water desalination), mining industry, or a combination thereof.

The aqueous feedwater solution 102 can comprise any type of water, treated or untreated. For example, the aqueous feedwater solution 102 can comprise hard water, hard brine, sea water, brackish water, fresh water, flowback or produced water, wastewater (e.g., reclaimed or recycled), river water, lake or pond water, aquifer water, brine (e.g., reservoir or synthetic brine), slickwater, or a combination thereof. In some examples, the aqueous feedwater solution 102 can comprise hard water, hard brine, sea water, brackish water, flowback or produced water, wastewater (e.g., reclaimed or recycled), brine (e.g., reservoir or synthetic brine), slickwater, or a combination thereof.

In some examples, the aqueous feedwater solution 102 can comprise wastewater, such as industrial wastewater and/or wastewater from unconventional energy production. In some examples, the aqueous feedwater solution 102 can comprise wastewater from gas and/or oil production from a subterranean formation (e.g., unconventional formation, conventional formation). In some examples, the aqueous feedwater solution 102 can comprise wastewater from gas and/or oil production from an unconventional subterranean formation (e.g., shale formation). In some examples, the aqueous feedwater solution 102 comprises unconventional oil wastewater (e.g., shale oil wastewater), unconventional gas wastewater (e.g., shale gas wastewater), conventional oil wastewater, conventional gas wastewater, or a combination thereof. In some examples, the aqueous feedwater solution 102 comprises mining wastewater, flue gas desulfurization wastewater (this is from coal power plant), chemical industry wastewater, or a combination thereof.

In some examples, the aqueous feedwater solution 102 has a total dissolved solids content of greater than 0 g/L (e.g., 1 g/L or more, 2 g/L or more, 3 g/L or more, 4 g/L or more, 5 g/L or more, 10 g/L or more, 15 g/L or more, 20 g/L or more, 25 g/L or more, 30 g/L or more, 35 g/L or more, 40 g/L or more, 45 g/L or more, 50 g/L or more, 55 g/L or more, 60 g/L or more, 65 g/L or more, 70 g/L or more, 75 g/L or more, 80 g/L or more, 85 g/L or more, 90 g/L or more, 95 g/L or more, 100 g/L or more, 110 g/L or more, 120 g/L or more, 130 g/L or more, 140 g/L or more, 150 g/L or more, 175 g/L or more, 200 g/L or more, or 225 g/L or more). In some examples, the aqueous feedwater solution 102 has a total dissolved solids content of 250 g/L or less (e.g., 225 g/L or less, 200 g/L or less, 175 g/L or less, 150 g/L or less, 140 g/L or less, 130 g/L or less, 120 g/L or less, 110 g/L or less, 100 g/L or less, 95 g/L or less, 90 g/L or less, 85 g/L or less, 80 g/L or less, 75 g/L or less, 70 g/L or less, 65 g/L or less, 60 g/L or less, 55 g/L or less, 50 g/L or less, 45 g/L or less, 40 g/L or less, 35 g/L or less, 30 g/L or less, 25 g/L or less, 20 g/L or less, 15 g/L or less, 10 g/L or less, or 5 g/L or less). The total dissolved solids content of the aqueous feedwater solution 102 can range from any of the minimum values described above to any of the maximum values described above. For example, the aqueous feedwater solution 102 can have a total dissolved solids content of from greater than 0 g/L to 250 g/L (e.g., from greater than 0 to 125 g/L, from 125 g/L to 150 g/L, from greater than 0 to 50 g/L, from 50 to 100 g/L, from 100 to 150 g/L, from 150 to 200 g/L, from 200 to 250 g/L, from greater than 0 to 225 g/L, from greater than 0 to 200 g/L, from greater than 0 to 175 g/L, from greater than 0 to 150 g/L, from greater than 0 to 100 g/L, from greater than 0 to 75 g/L, from greater than 0 to 50 g/L, from greater than 0 to 40 g/L, from greater than 0 to 30 g/L, from greater than 0 to 20 g/L, from greater than 0 to 10 g/L, from 1 to 250 g/L, from 5 to 250 g/L, from 10 to 250 g/L, from 20 to 250 g/L, from 30 to 250 g/L, from 40 to 250 g/L, from 50 to 250 g/L, from 75 to 250 g/L, from 100 to 250 g/L, from 150 to 250 g/L, from 175 to 250 g/L, from 5 to 225 g/L, or from 10 to 200 g/L).

In some examples, the total dissolved solids of the diluate stream 104 is less than that of the aqueous feedwater solution 102.

In some examples, the total dissolved solids of brine stream 106 is greater than that of the aqueous feedwater solution 102.

In some examples, the water stream 112 is substantially free of dissolved solids (e.g., has a total dissolved solids content if substantially 0).

Also disclosed herein are methods of use of any of the systems disclosed herein. For example, the methods can comprise using the system 100 to treat the aqueous feedwater solution 102.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

Brine management is an important technical challenge in the water and wastewater industry. Of the few limited brine management strategies, zero liquid discharge (ZLD) is increasingly becoming the standard regulation requirement. Existing treatment trains for zero liquid discharge all rely on mechanical vapor compression (MVC) for brine crystallization. But mechanical vapor compression is very energy intensive, typically consuming 20-70 kWhₑ m⁻³, and has very high capital costs. Mechanical vapor compression is among the most energy-efficient thermal distillation processes but is still highly energy-intensive due to the presence of a phase change. To minimize the cost of zero liquid discharge, existing approaches focus on concentrating the brine to the greatest extent possible to minimize the capacity of the mechanical vapor compression brine crystallizer. However, the most ideal zero liquid discharge treatment train should operate without mechanical vapor compression or any thermally driven processes, which are currently non-existing.

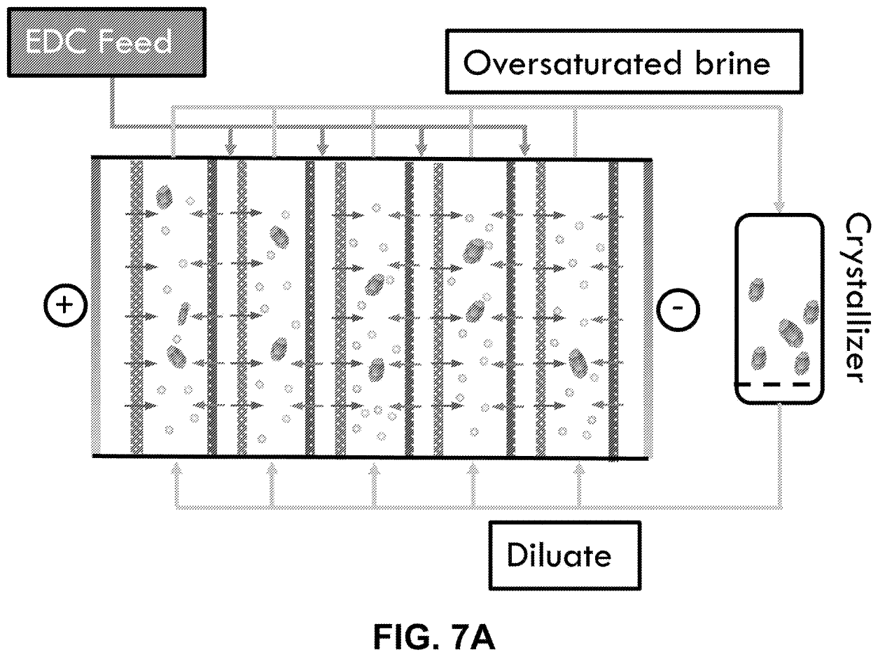

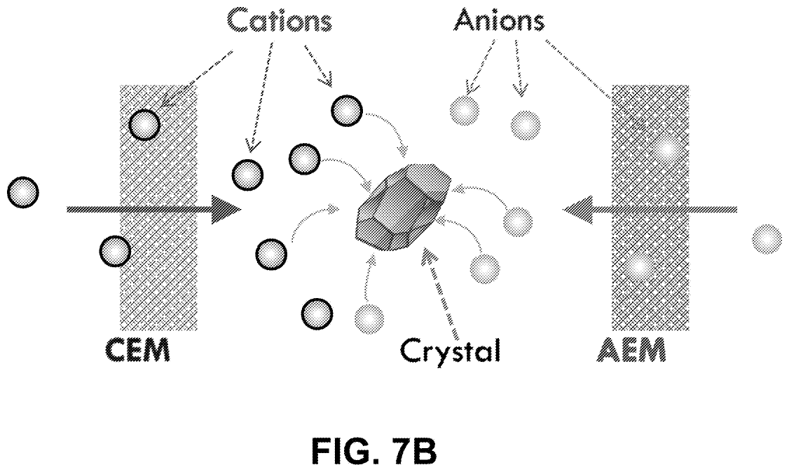

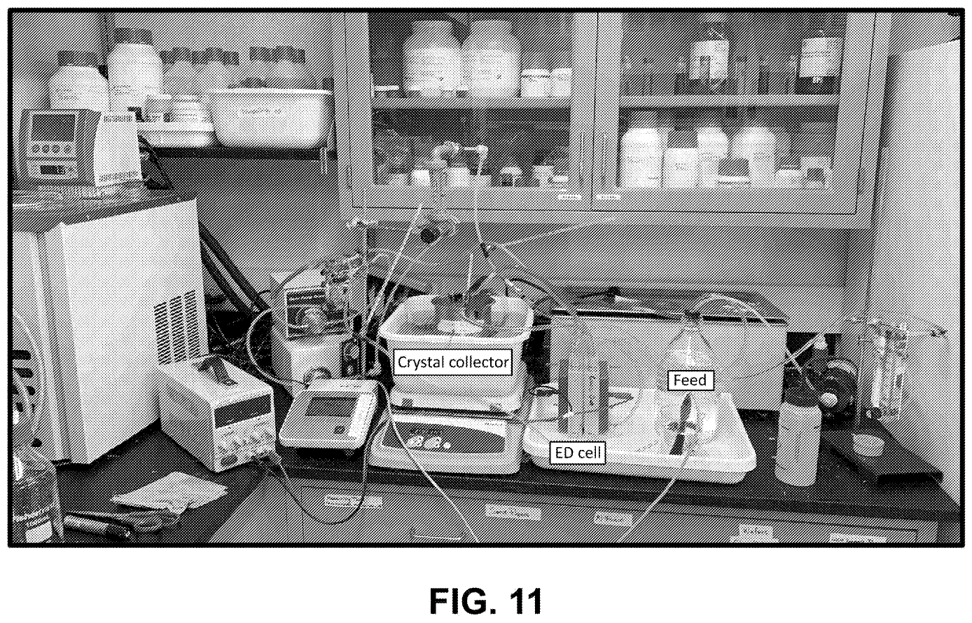

Described herein is a non-thermal zero liquid discharge method using an integrated system that couples an electro-dialytic crystallizer (EDC) and reverse osmosis (RO). The electro-dialytic crystallizer system is a non-thermal process that can achieve crystallization with very high energy efficiency. The feedwater of the electro-dialytic crystallizer (which is the brine to be treated) goes through the feed channels (colored in light blue in FIG. 7A). Under the influence of an applied electric field, the ions in the feed channels transport across the ion exchange membranes (IEMs). Specifically, the cations will transport across the cation exchange membrane (CEM), and the anions across the anion exchange membrane (AEM), to the brine channels (colored in yellow in FIG. 7A). The brine channels have a salt concentration that equals or exceeds the solubility limit. Therefore, precipitation occurs in the brine channels and forms salt crystals. Crystals will continue to form as long as ions are constantly supplied to the brine channels from the feedwater channels (FIG. 7B). At steady state, a certain level of oversaturation would be maintained in the brine channels. A photograph of an example system is also shown in FIG. 11.

There are two possible configurations for the electro-dialytic crystallizer brine channels. In the first configuration, the solution in the brine channel (including the precipitated crystals) will be constantly recirculated between the electrodialysis (ED) cell and a crystal collector.

The crystal collector can be (1) a stirred tank with a different temperature (as compared to that of the electrodialysis cell) to promote the formation of precipitates; or (2) a microfiltration or ultrafiltration system to collect the precipitated crystals and prevent the large crystals from reentering the brine channels of the electro-dialytic crystallizer; or (3) the combination of both (1) and (2).

In some examples, the crystal collector is a microfiltration or ultrafiltration system installed outside the electro-dialytic crystallizer system to collect the precipitated crystals and prevent the large crystals from reentering the brine channels of the electro-dialytic crystallizer. The crystals can be collected from the microfiltration or ultrafiltration system periodically.

In the second configuration, the brine channels are interconnected to each other at their bottoms. Crystals forming within each brine channels will grow and settle to the bottom of the system. The sedimented crystals will be collected periodically.

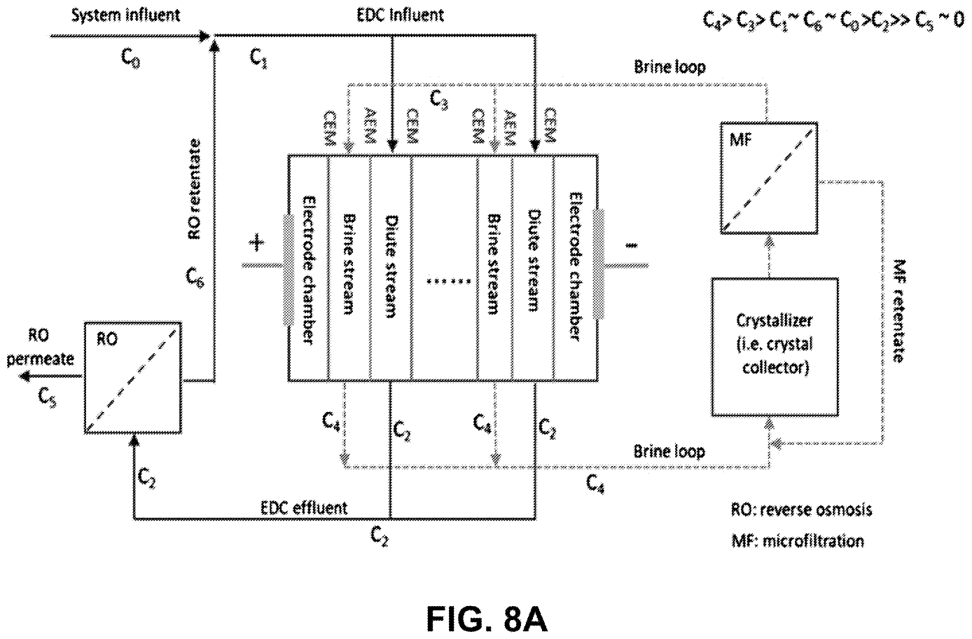

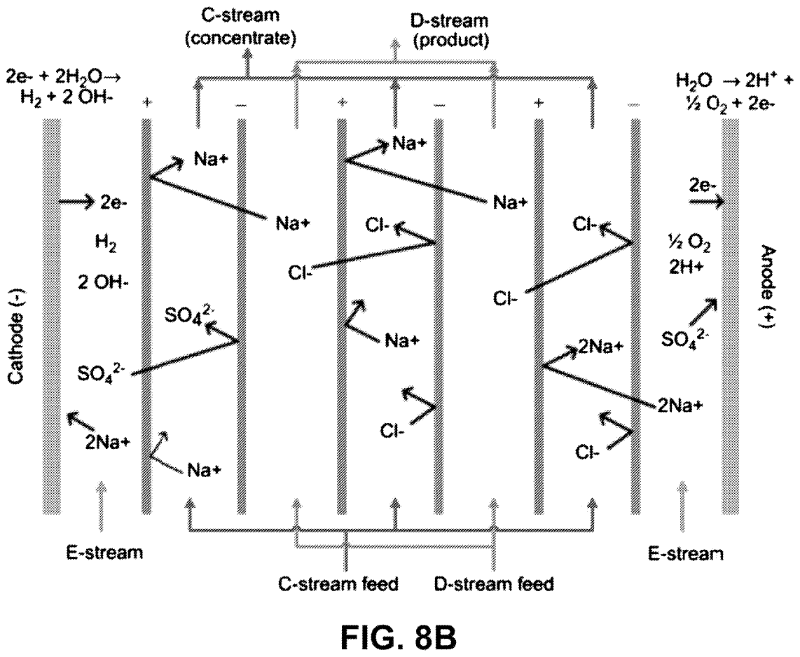

The effluent of the electro-dialytic crystallizer feed channels, which is referred to as the electro-dialytic crystallizer diluate, will be sent off to a reverse osmosis (RO) system to produce high-quality water (i.e., the reverse osmosis permeate) (FIG. 8A). The reverse osmosis brine generated will be mixed with influent brine to the hybrid system to become the feedwater of the electro-dialytic crystallizer. An energy recovery device may be installed for the reverse osmosis system to reduce its energy consumption.

Further description of the electro-dialytic crystallizer/reverse osmosis treatment train (based on FIG. 8A) is provided below. An energy recovery device may be installed for the reverse osmosis system to reduce its energy consumption, which is not shown in FIG. 8A. The system boundary of electro-dialytic crystallizer is highlighted by the red dashed frame. Electro-dialytic crystallizer includes electrodialysis cell, the crystal collector, and the circulate stream (the over-saturated brine). The total dissolved solids of the different streams typically follow this order: C₄>C₃>C₁˜C₀˜C₆>C₂>>C₅˜0. The temperature of the crystal collector (T_{Cr}) can be slightly lower than the temperature of the electrodialysis cell (T_{ED}) for salts whose solubility positively correlates with temperature. T_{Cr} can be slighter higher than T_{ED} for salts whose solubility negatively correlates with temperature. When the brine comes out from the crystal collector, its temperature can be adjusted back to T_{ED} before it goes to electrodialysis cell again. A schematic diagram of a general electrodialysis cell is shown in FIG. 8B.

Electro-dialytic crystallization can potentially replace mechanical vapor compression (MVC) or other thermal evaporation methods for crystallizing minerals and recovering water from the brine, which can be used in many chemical industries involving mineral crystallization/production and/or for zero liquid discharge (ZLD), which has a large and continuously growing demand as the requirement for managing the brine resulting from the power industry, chemical industry, food industry, oil and gas industry (e.g., hydraulic fracturing), and inland brackish water desalination.

Electro-dialytic crystallization is the first technology for brine crystallization without using heat (whether the heat is provided as the primary energy, as in multi-stage flash distillation or multi-effect distillation, or generated from electricity, as in mechanical vapor compression). The working mechanism of electro-dialytic crystallization does not involve phase change of water (as in distillation) or the use of organic solvents (as in temperature-swing solvent extraction). Electro-dialytic crystallization differs from conventional electrodialysis (ED) or electrodialysis reversal (EDR) in multiple aspects.

Difference between electro-dialytic crystallizer and zero liquid discharge treatment trains using electrodialysis. Because electrodialysis or electrodialysis reversal (EDR) can treat highly saline brine with a salinity exceeding the operation limit of reverse osmosis, electrodialysis (or electrodialysis reversal) has been applied in zero liquid discharge treatment trains in previous studies to concentrate the brine before sending the brine to mechanical vapor compression or other evaporative processes. However, the electro-dialytic crystallizer proposed herein differs fundamentally from electrodialysis used in zero liquid discharge treatment trains that rely on mechanical vapor compression or other thermal distillation for brine crystallization in one or more of the following aspects: brine channel design, flow configuration, crystallization, and effluent brine treatment.

Brine channel design. Nearly all electrodialysis cells (in existing zero liquid discharge systems) have very thin feed and brine channels filled with a porous spacer. The main rationale is to reduce the cell resistance which is proportional to the channel thickness at a given salinity. The very thin brine channel is a major reason why electrodialysis could not be used for crystallization as crystals will clog the spacer, increase flow resistance, and eventually lead to system failure.

Meanwhile, the brine channels in the electro-dialytic crystallizer are substantially wider. They can be either filled with thick and highly porous spacers, or just maintained using certain frame structures. The thick brine channel does not lead to high cell resistance because the salinity in the brine channel is very high (at or beyond solubility limit).

Flow configuration. In conventional electrodialysis or electrodialysis reversal, the same feed water is divided into two parts, one flowing into concentrate (or brine) channel and the other into the diluate channel. In other words, there are two streams going through an electrodialysis or electrodialysis reversal system.

Meanwhile, in the electro-dialytic crystallizer, the entire stream of feedwater flows through the electro-dialytic crystallizer diluate channel and exits as the diluate. The brine stream is recirculated between the brine channels in the electrodialysis cell and crystallizer, i.e., the brine channels of the electrodialysis cell and the crystallizer comprise a closed loop. In other words, there is one stream going through an electro-dialytic crystallizer.

Crystallization. In electrodialysis (in existing zero liquid discharge systems), crystallization should not occur or is considered undesirable in a conventional electrodialysis cell. Meanwhile, crystallization is intentionally induced in the brine channels of an electro-dialytic crystallizer cell.

Effluent brine treatment. In electrodialysis (in existing zero liquid discharge systems), another process (most commonly mechanical vapor compression) follows electrodialysis to achieve further brine concentration and eventually crystallization. Meanwhile, the electro-dialytic crystallizer has no effluent brine.

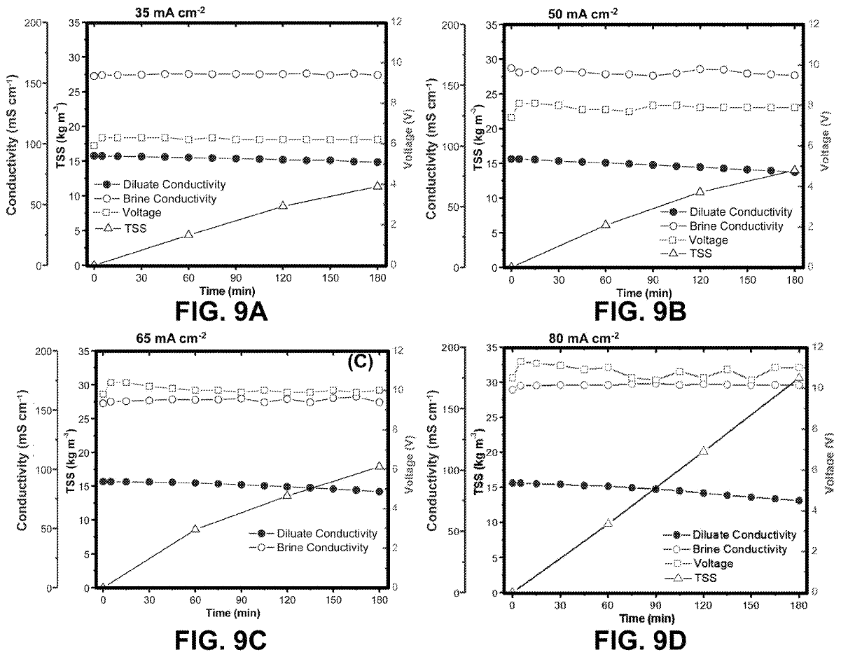

Results. Experiments were performed using an electro-dialytic crystallizer system where a stirred tank with a different temperature is used as the crystal collector. In these experiments, specifically, the temperature of the crystal collector is 19° C. and the inlet temperature of the electrodialysis cell is ˜22.5° C. Na₂SO₄ was used as the model salts in solutions. The results of these experiments are shown in FIG. 9A-FIG. 9D. In each experiment, a constant current was applied to the electrodialysis cell and (1) the conductivity of the diluate stream (solid blue circles), (2) the conductivity of the brine stream (open blue circles), (3) the cell voltage (red square), and (4) the total suspended solid, i.e., the mass of crystal precipitate in a unit volume of the oversaturated brine (green triangles), were observed.

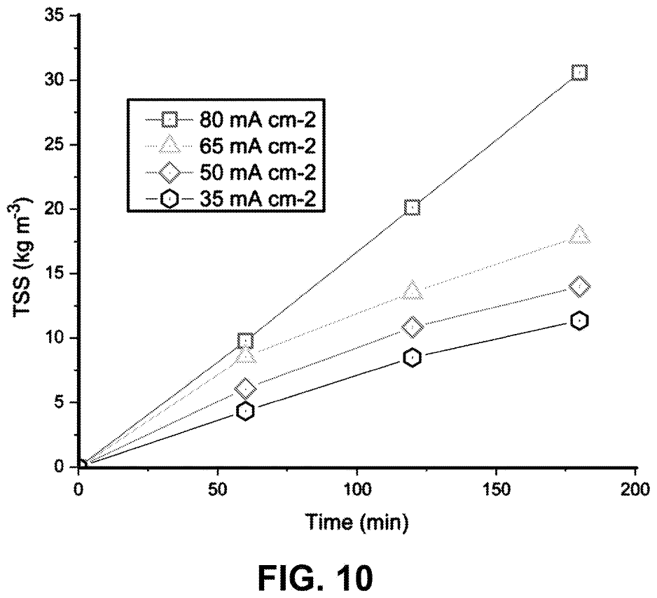

As FIG. 9A-FIG. 9D show, the voltage and the brine conductivity remained constant over time, whereas the diluate conductivity decreased over time as more ions transport across the ion exchange membranes to the oversaturated brine stream. Most importantly, the total suspended solid (TSS) in the brine stream also increased over time, indicating the formation of crystal precipitates. The total suspended solid level as a function of operation time for different current densities is summarized in FIG. 10.

### Example 2

Brine management is becoming growingly important for the sustainability of a variety of industries, which include the chemical, food, oil and gas industries, power generation and inland brackish water desalination. In many cases, zero liquid discharge (ZLD) is the preferred approach of brine management. However, achieving cost-effective zero liquid discharge is technically challenging due to the very high salinity (i.e., total dissolved solids, or TDS) of the brine (Tong T. and Elimelech M., Environ. Sci. Technol. 2016, 50, 6846). The state-of-the-art desalination process, reverse osmosis (RO), can only concentrate the brine to a limited level of total dissolved solids. The ultrahigh osmotic pressure and strong scaling potential of hypersaline brine makes conventional reverse osmosis inapplicable. Existing processes for concentrating and crystalizing hypersaline brine mainly rely on evaporative processes that are intrinsically energy intensive due to phase change. Among the several evaporative processes, mechanical vapor compression (MVC) is currently the most widely used for zero liquid discharge due to its technical maturity and suitability in relatively small scale (i.e., substantially smaller than municipal scale) applications. Nonetheless, mechanical vapor compression is still energy intensive, typically consuming 20-40 kWhₑ per m³ of the treated brine (McGinnis et al., Desalination, 2013, 312, 67). Moreover, mechanical vapor compression also has the additional limitation of the very high capital cost.

Described herein is a cost-effective brine concentration/crystallization process with the potential to substantially outperform mechanical vapor compression and other existing brine crystallization processes in energy and cost efficiency. The systems and methods described herein can potentially achieve entirely electrified zero liquid discharge. The systems and methods described herein can also achieve fractionation of mineral salts and enable valorization of waste brines that typically contain multiple constituents.

A non-thermal zero liquid discharge system hybridizing reverse osmosis and an electro-dialytic crystallizer (EDC) is described herein. The electro-dialytic crystallizer is based on the principle of electrodialysis (ED) (Al-Amshawee et al., Chem. Eng. J. 2020, 380, 12231), but at the same time has a design that enables the technology to achieve the functionality that cannot be attained using conventional electrodialysis (or electrodialysis reversal, EDR).

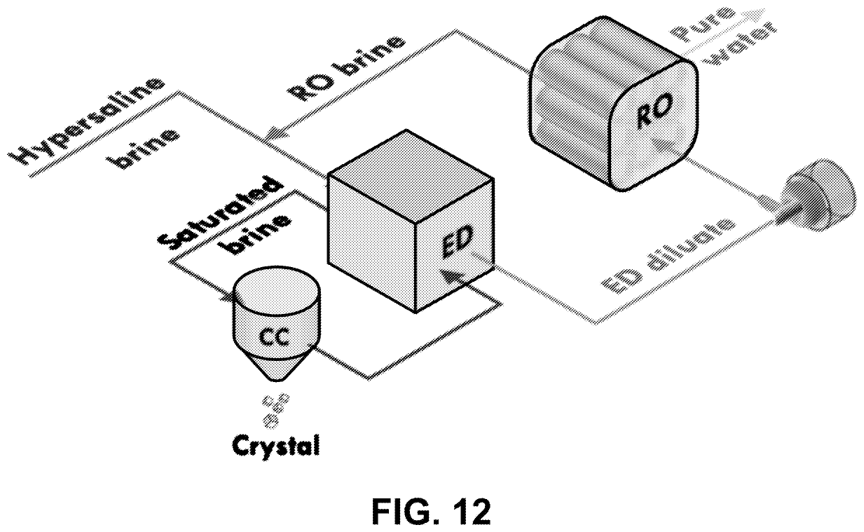

One possible configuration of electro-dialytic crystallizer is shown in FIG. 7A. In this configuration, the electro-dialytic crystallizer feed solution enters the feed channels (blue), becomes deionized under the influence of the electric field, and exits the feed channels as the diluate. The stream receiving the ions is constantly recirculated between the wide and spacer-free brine channels (yellow) and an external crystal collector (e.g., a microfiltration unit). This recirculated oversaturated brine is where mineral crystals are formed due to the electrodialysis-sustained oversaturation (FIG. 7B). The diluate from the feed channels, which still contains a moderate level of total dissolved solids, will be further desalinated by a reverse osmosis unit. The reverse osmosis brine will mix with the influent to zero liquid discharge system to become the electro-dialytic crystallizer feed solution (FIG. 8A-FIG. 8B, FIG. 12).

The electro-dialytic crystallizer differs from conventional electrodialysis/electrodialysis reversal systems in several aspects, including flow configurations, channel design and functionality. The feed solution of electrodialysis/electrodialysis reversal is divided into two streams with one becoming concentrated and the other diluted, whereas there is only one stream passing through electro-dialytic crystallizer. Crystallization is minimized in electrodialysis/electrodialysis reversal to prevent process failure, but intentionally induced in electro-dialytic crystallizer that can sustain steady-state crystallization due to its unique system design and operation. Consequently, electrodialysis/electrodialysis reversal is usually followed by an energy-intensive evaporative crystallizer but electro-dialytic crystallizer itself is the crystallizer. The elimination of evaporative crystallizer is transformative and can potentially lead to highly energy-efficiency and entirely electrified zero liquid discharge. Indeed, preliminary analysis suggests that electro-dialytic crystallizer theoretically consumes less energy than electrodialysis/electrodialysis reversal itself (not including the evaporative crystallization), and the electro-dialytic crystallizer-based hybrid zero liquid discharge system can potentially outperform existing zero liquid discharge treatment trains.

The deliverables of the project include (a) a bench-scale electro-dialytic crystallizer system capable of producing mineral crystals with sustained performance; (b) a systematic understanding of the relationship between electro-dialytic crystallizer performance, operation conditions, and feed solution composition; (c) a theoretical analysis and optimization of the energy efficiency of the full-scale and integrated electro-dialytic crystallizer-reverse osmosis zero liquid discharge system; (d) a fundamental understanding of whether and how electro-dialytic crystallizer can potentially enable fractionation of mixed salts into pure crystals; and (e) technoeconomic analysis and life-cycle assessment of the electro-dialytic crystallizer-reverse osmosis system for zero liquid discharge.

Potential mineral scaling on ion exchange membranes and terminal electrodes can be mitigated by operation with high crossflow rates and/or other methods (e.g., sonication). The system's capability in mixed salt fractionation is a substantial bonus to the proposed system, but the lack of it does not undermine the system's competitive edge over existing zero liquid discharge technologies.

The electro-dialytic crystallizer builds on the scientific principle of the relatively mature electrodialysis/electrodialysis reversal process but incorporates features that enable crystallization with relatively low energy consumption. The systems and methods described herein address major research gaps toward the future adoption of electro-dialytic crystallizer by (a) providing experimental proof of electro-dialytic crystallizer's technical capability; (b) acquiring a systematic understanding of the energy consumption of an electro-dialytic crystallizer-based zero liquid discharge treatment train; and (c) addressing practical challenges (scaling) and exploring the additional functionality (mixed salt fractionation) of electro-dialytic crystallization. As electro-dialytic crystallization is a brine concentration/crystallization process that neither relies on evaporation nor requires any heat input, the successful development of electro-dialytic crystallization will likely have transformative impact on brine management and zero liquid discharge by making it fully electrified and substantially more cost-effective and adaptable than existing evaporation-based approaches. If mixed salt fractionation is proven effective, zero liquid discharge may even have the opportunity to convert brine management, which is currently a regulation-driven treatment need, to a profitable and sustainable practice of waste valorization.

### Example 3—Electro-dialytic Crystallizer (EDC) for Energy Efficient Zero-Liquid Discharge

The last and often most costly and energy-intensive step in intensified brine management processes is crystallizing salts out from saturated brines. While disposal is often the preferred solution for brine management due to its low cost, in some cases zero liquid discharge (ZLD) is required (Tong T. and Elimelech M., Environ. Sci. Technol. 2016, 50, 6846). Conventional reverse osmosis (RO) can only concentrate the brine to ˜100 g/L before the osmotic pressure and scaling potential of the brine make further concentration unviable, and it is for these reasons that thermal processes are currently applied for brine concentration. However, thermal processes utilize high temperatures and require exotic metals to contain the hot and corrosive brine, which translates into high operational and capital costs (Yaqub, M. and Lee, W., Science of the total environment, 2019. 681, 551).

Described herein is a modular brine concentration/crystallization process that is substantially more energy efficient than the current state-of-the-art thermal processes. A brine crystallization process called electro-dialytic crystallization (EDC) is investigated, which integrates electrodialysis and crystallization into a single system to enable crystallization without evaporation or large temperature swings, thereby potentially improving the energy efficiency and reducing the cost of crystallization. An important element of the electro-dialytic crystallizer is the use of the electrodialysis phenomenon to maintain a saturated brine stream for continuous salt precipitation. System-scale modeling can be performed to guide design and optimization of electro-dialytic crystallizer, experiments can be performed to validate the concept and, techno-economic analysis, life cycle assessment, and market analysis can be conducted to evaluate the potential of electro-dialytic crystallizer for future practical adoption.

The project can address a major knowledge gap toward the future adoption of electro-dialytic crystallizer. A fully successful project can provide experimental proof of electro-dialytic crystallizer's technical capability and also pave the way towards making zero liquid discharge more widespread and potentially opening the door to recovering resources from concentrated brines.

A simplified schematic of the electro-dialytic crystallizer process coupled with reverse osmosis for zero liquid discharge without thermal evaporation is shown in FIG. 12.

### Example 4—Electro-Dialytic Crystallization for Energy-Efficient Brine Management

Abstract. The management of hypersaline brines, i.e., water of very high salinity, is a technical challenge that has received increasing attention due to their growing volume, significant environmental impacts, and increasingly stringently regulations. The state-of-the-art method for treating hypersaline brine to achieve zero liquid discharge (ZLD) is based on evaporation which is energy intensive and often costly. Herein, electro-dialytic crystallization (EDC) is presented as a process to electrify crystallization and zero liquid discharge without evaporation. In an electro-dialytic crystallization process, the brine stream recirculating between the electrodialysis cell and a crystallizer remains oversaturated via continuous electromigration of ions from the feed stream across ion exchange membranes. Na₂SO₄ was used as the model salt to demonstrate the feasibility of electro-dialytic crystallization and to perform a systematic investigation of how crystallization kinetics and particle size distribution depend on current density and crystallization mode. The criterion of crystalizability and the dependency of crystalizability on salt species, membrane properties, and operating conditions were also investigated. Lastly, a preliminary analysis of the energy consumption of an electro-dialytic crystallization-reverse osmosis treatment train for achieving zero liquid discharge of a Na₂SO₄ brine was performed. Overall, this study provides a proof-of-concept for electro-dialytic crystallization as an electrically driven and non-evaporative crystallization process and lays the foundation for its future technical development and optimization.

Introduction. The management of hazardous high-salinity brines represents a prominent environmental challenge to water sustainability. A large volume of highly saline brine is generated from the energy, mining, and desalination industries (Tong T et al. Environmental Science & Technology 2016, 50(13), 6846-6855; Karanikola V et al. Environmental Science & Technology 2018, 52(24), 14362-14370; Tian WD et al. ACS Sustain Chem Eng 2019, 7(14), 12358-12368; Chang H et al. Desalination 2019, 455, 34-57; Tong TZ et al. Front Env Sci Eng 2019, 13(4), 63; Shemer H et al. Desalination 2017, 424, 10-16). Current brine management commonly relies on evaporation ponds or injection into deep subterranean formations, which are plagued with the concerns of induced seismicity, negative impacts on groundwater, and the removal of accessible water from the hydrologic cycle (Tong T et al. Environmental Science & Technology 2016, 50(13), 6846-6855; Ellsworth WL. Science 2013, 341(6142), 1225942; Scanlon BR et al. Seismological Research Letters 2018, 90, 171-182; Davenport DM et al. Environ Sci Tech Let 2018, 5(8), 467-475; Tong TZ et al. Environmental Science & Technology 2016, 50(13), 6846-6855). Therefore, zero liquid discharge (ZLD) is the preferred brine management approach and a key component of water circularity (Mauter MS et al. Energy & Environmental Science 2020, 13(10), 3180-3184). However, achieving cost-effective zero liquid discharge is technically challenging due to the very high salinity (i.e., total dissolved solids, or TDS) of the brines (Tong T et al. Environmental Science & Technology 2016, 50(13), 6846-6855). The state-of-the-art desalination process, reverse osmosis (RO), can only concentrate the brine to a limited level of total dissolved solids (Tong T et al. Environmental Science & Technology 2016, 50(13), 6846-6855; Davenport DM et al. Environ Sci Tech Let 2018, 5(8), 467-475). Consequently, most zero liquid discharge systems rely on evaporative methods to concentrate brine and attain crystallization.

Evaporative processes are intrinsically energy intensive due to the liquid-to-vapor phase change. The latent heat of vaporization (>650 kWh m⁻³) is nearly two orders of magnitude higher than the Gibbs free energy of zero liquid discharge (typically <10 kWh m⁻³). Mechanical vapor compression (MVC) is currently the most mature technology for zero liquid discharge due to its excellent performance in latent heat recovery. Nonetheless, mechanical vapor compression is still energy intensive, typically consuming 30-40 kWhₑm⁻³ (subscript “e” for electricity) for brine concentration and >50 kWhₑm⁻³ for crystallization (Mickley M. Survey of High-Recovery and Zero Liquid Discharge Technologies for Water Utilities; Alexandria, VA, 2008; Burbano AB. Demonstration of Membrane Zero Liquid Discharge for Drinking Water Systems—A Literature Review; Alexandria, VA, 2012; McGinnis RL et al. Desalination 2013, 312, 67-74). Further, mechanical vapor compression requires high capital cost due to the use of expensive materials to prevent corrosion caused by the boiling brine (Tong T et al. Environmental Science & Technology 2016, 50(13), 6846-6855). In one example of using mechanical vapor compression for zero liquid discharge (https://www.saltworkstech.com/articles/what-is-zero-liquid-discharge-why-is-it-important/), the brine concentration and crystallization steps contributed to ˜90% of the total cost, with the crystallization step processing only 12% of the brine volume but accounting for 41% of the treatment cost. Developing non-evaporative process that enable brine crystallization, therefore, will have a transformative impact by significantly reducing the cost, energy consumption, and carbon footprint of zero liquid discharge.

Electrodialysis (ED) is an electrochemical separation process that has been used in various desalination applications and explored for concentrating reverse osmosis brine before it is sent to mechanical vapor compression-based brine concentrator and crystallizer. In a conventional electrodialysis process, saline feed water enters an electrodialysis stack comprising multiple pairs of cation exchange membranes (CEMs) and anion exchange membranes (AEMs) placed alternately. Under an applied electric field, ions in the feed channels migrate to the two adjacent brine channels, producing a diluate stream with a reduced salinity and brine streams with a higher salinity. Despite its ability to achieve higher salinities of brine than conventional reverse osmosis, current electrodialysis systems can at best function as a brine concentration unit for volume reduction but cannot achieve crystallization.

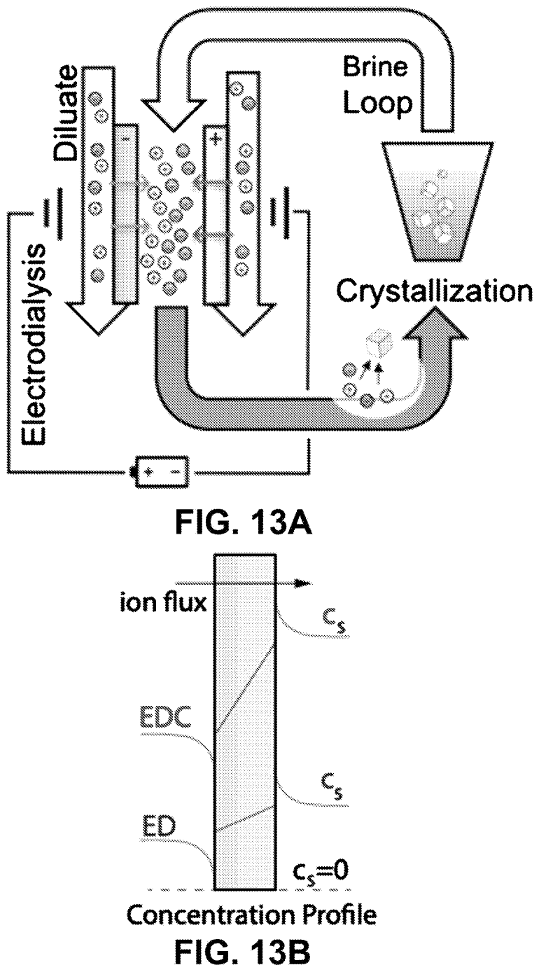

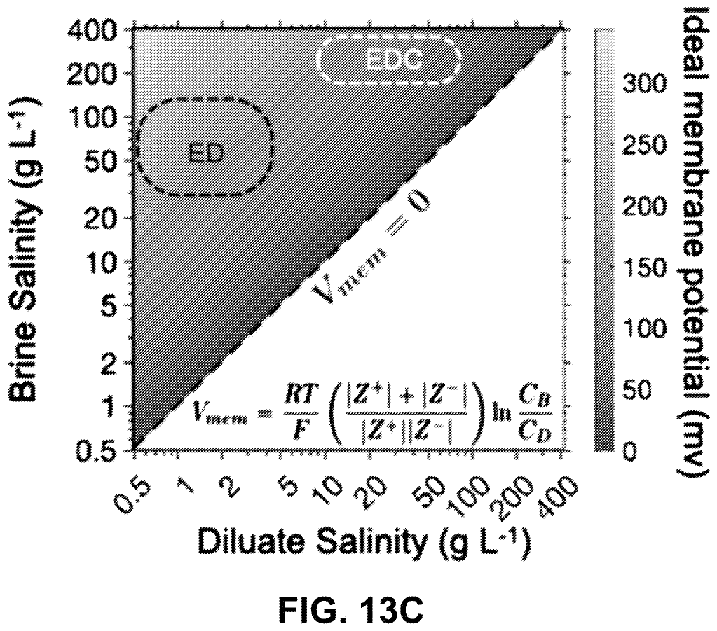

Herein, a variant of electrodialysis is introduced that electrifies brine crystallization without a subsequent mechanical vapor compression or any evaporative process. This process, namely electro-dialytic crystallization (EDC), integrates an electrodialysis with a crystallizer in a way that the brine stream is constantly recirculated between the brine channels of the electrodialysis cell and the crystallizer. Under an applied electric field, the ions in the feed stream are constantly drawn to the recirculated brine stream, which pushes the brine stream concentration beyond the salt's solubility limit and thereby induces crystallization (FIG. 13A).

Electro-dialytic crystallization differs from conventional electrodialysis in several aspects. While there are two effluent streams (i.e., diluate and brine) in an electrodialysis process, there is only one effluent stream (i.e., diluate stream) for an electro-dialytic crystallization system. Compared to electrodialysis, electro-dialytic crystallization is designed to work with a higher feed concentration to achieve a higher brine concentration (FIG. 13B). Despite a higher trans-membrane concentration difference to overcome, the minimum energy to transfer an ion in electro-dialytic crystallization can be lower than electrodialysis for producing freshwater because the membrane potential (or Donnan potential) is dependent on the ratio, but not the difference, of ion concentrations across the membrane (FIG. 13C). The membrane potential of the electro-dialytic crystallization can be relatively low as salinity in both the feed and brine channels are at the same order of magnitude.

In this study, the feasibility of electro-dialytic crystallization is demonstrated using Na₂SO₄ as the feed solution with two different operating modes. The impacts of current density and crystallization mode on crystallization kinetics and morphology of the resulting crystals is evaluated. The dependency of crystalizability on salt species and operating conditions is then investigated and a theoretical framework to determine crystalizability in electro-dialytic crystallization is established. Lastly, the energy consumption of an integrated electro-dialytic crystallization/reverse osmosis system for zero liquid discharge is estimated.

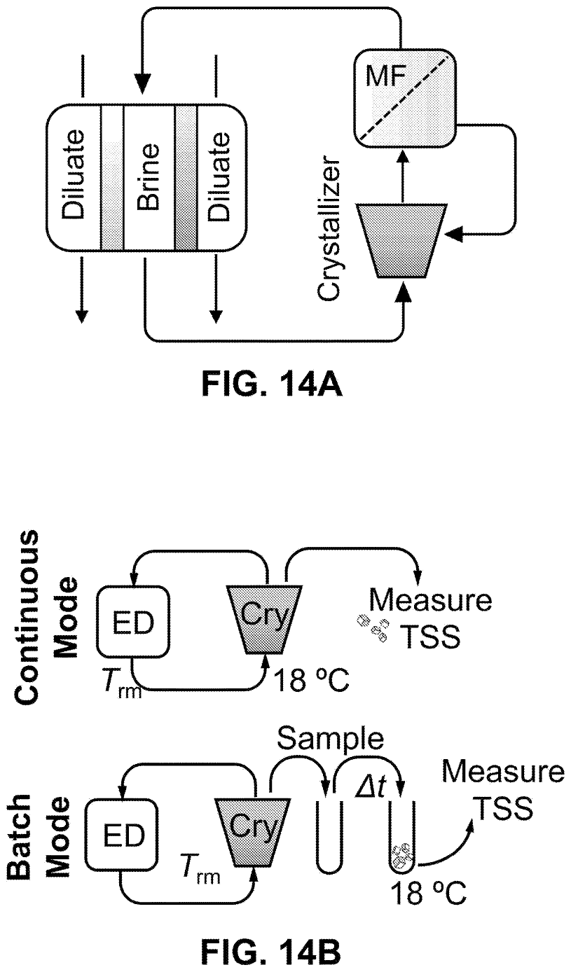

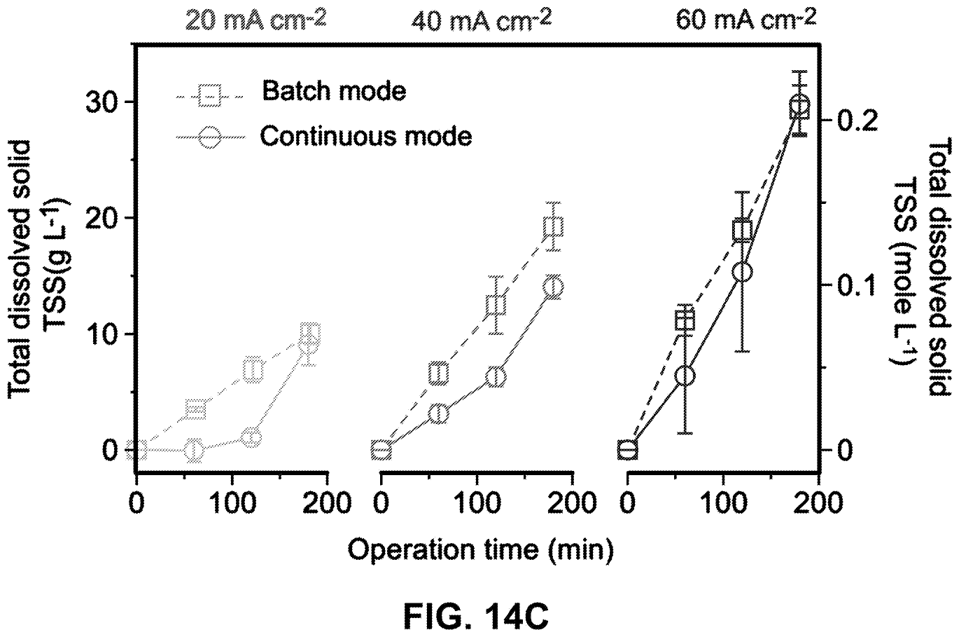

Proof-of-concept, kinetics, and particle size distribution for electro-dialytic crystallization of Sodium Sulfate. The feasibility of electro-dialytic crystallization was demonstrated using a bench-scale system with a 6 wt. % (63.8 g L⁻¹) Na₂SO₄ solution as the diluate stream influent. The brine loop contained a solution of 192 g L⁻¹ Na₂SO₄ (its solubility at 20° C.). The supernatant of the crystallizer was filtered using crossflow microfiltration (MF) before reentering the electrodialysis cell to minimize clogging the brine channel of the electrodialysis cell by crystals (FIG. 14A). Two operating modes, namely continuous and batch modes, were used to evaluate electro-dialytic crystallization performance. In the continuous mode, the temperature of the crystallizer was controlled at 18° C. and crystals were continuously generated in the crystallizer (FIG. 14B). In the batch mode, no temperature control was applied to the crystallizer, but brine collected from the crystallizer was cooled to 18° C. in an external water bath for an extensive period of time to maximize crystal production. While the continuous mode is more practically relevant, the batch mode provides a limit of crystal production by removing the constraint of crystallization kinetics.

The impact of current density on the crystallization kinetics was evaluated using three current densities (i.e., 20, 40, and 60 mA cm⁻²). Electro-dialytic crystallization was able to produce Na₂SO₄ crystals at all the current densities, as the total suspended solids (TSS, i.e., mass of crystal particles per volume of water) increased over time (FIG. 14C). It should be noted that the reported total suspended solids have been corrected for background precipitation and thus only reflect crystal production due to trans-membrane ion transport. Regardless of current density, the total suspended solids measured using the batch mode was higher than the total suspended solids measured using the continuous mode at the beginning stage of the experiments, which was likely due to limited crystallization kinetics. In other words, crystals may not form when the brine concentration reached or even exceeded solubility, which led to oversaturation of the brine in the continuous mode. As the total suspended solids values from the batch mode were measured using practically infinite time, they more closely represent what could theoretically be extracted when the brines reached equilibrium. Given more time for crystallization, continuous mode electro-dialytic crystallization could, in certain cases (e.g., 20 and 60 mA cm⁻²), generate as much total suspended solids as batch mode electro-dialytic crystallization towards the end of the 3-hr experiments (FIG. 14C).

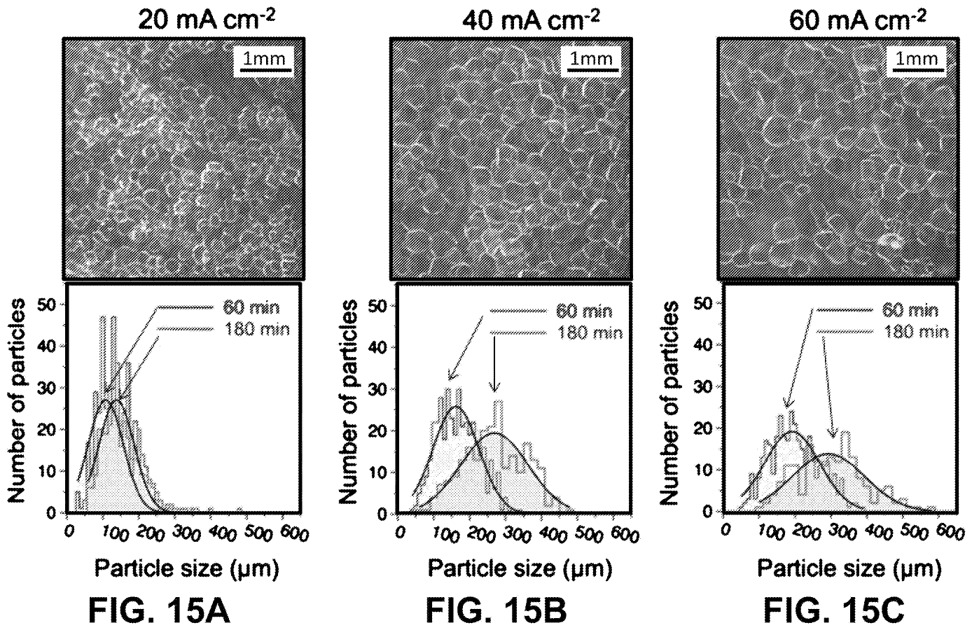

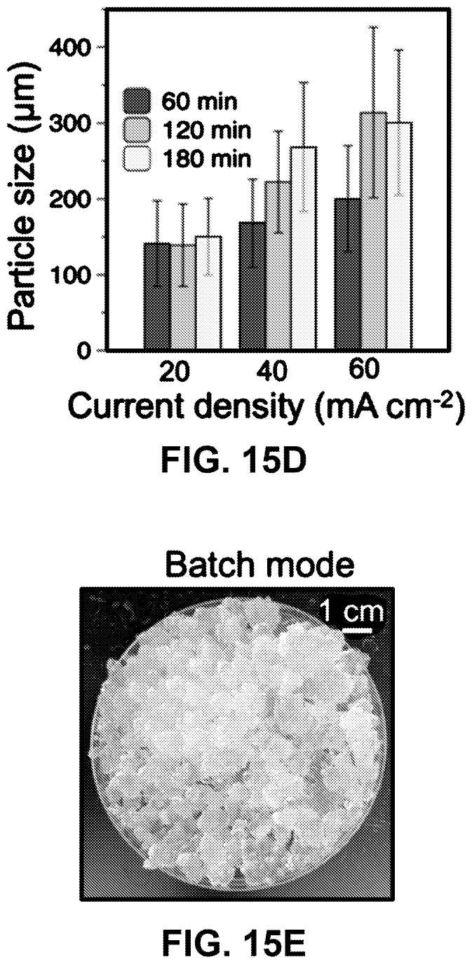

The particle size distributions of the Na₂SO₄ crystals resulting from electro-dialytic crystallization using continuous mode depend on both current density and operation time (FIG. 15A-FIG. 15E). In general, the Na₂SO₄ crystals have an average particle size (diameter) of hundreds of micrometers (FIG. 15A-FIG. 15D). The average particle size at the same crystallization time increased systematically with a higher current density. At 20 mA cm⁻², no significant change of particle size was observed with a longer crystallization time (FIG. 15A, FIG. 15D). In comparison, the particles grew significantly larger with a wider size distribution over a longer crystallization time when the current densities were 40 and 60 mA cm⁻² (FIG. 15B-FIG. 15D). Regardless of current density, batch mode electro-dialytic crystallization generated much larger, centimeter-scale crystals (FIG. 15E).

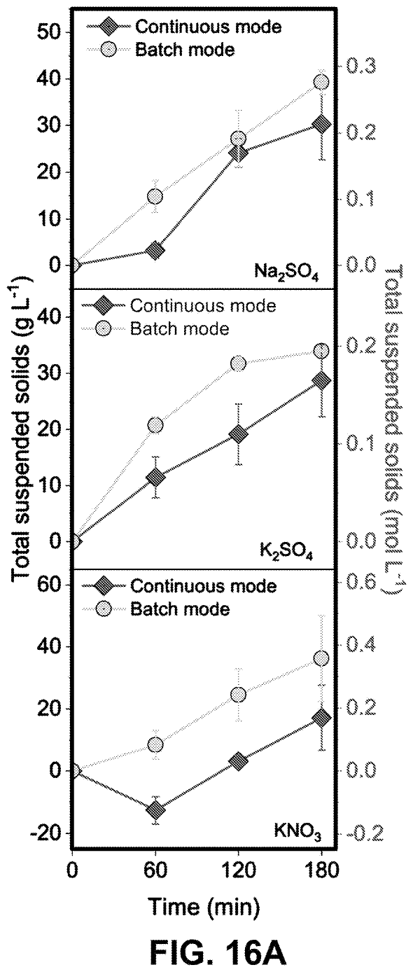

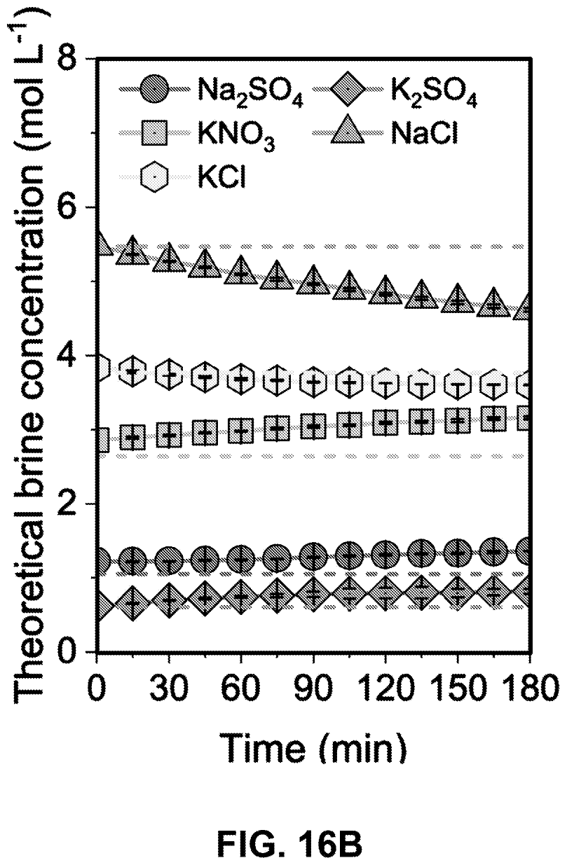

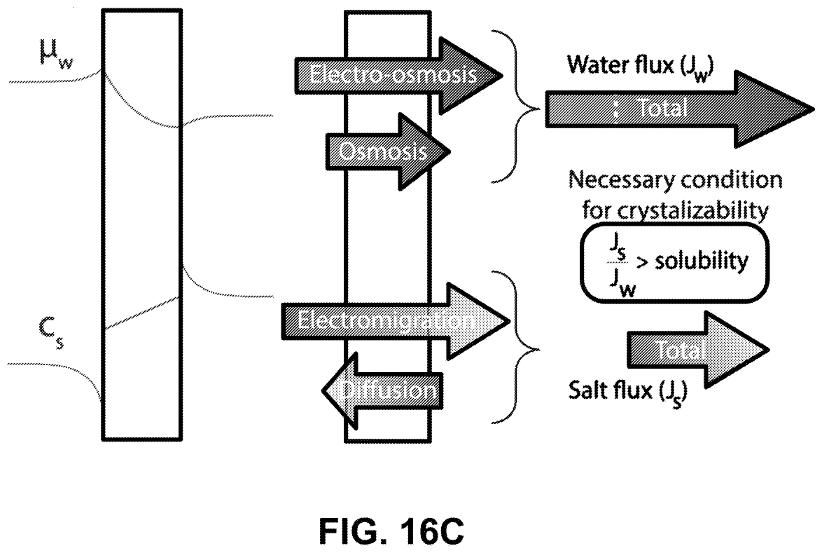

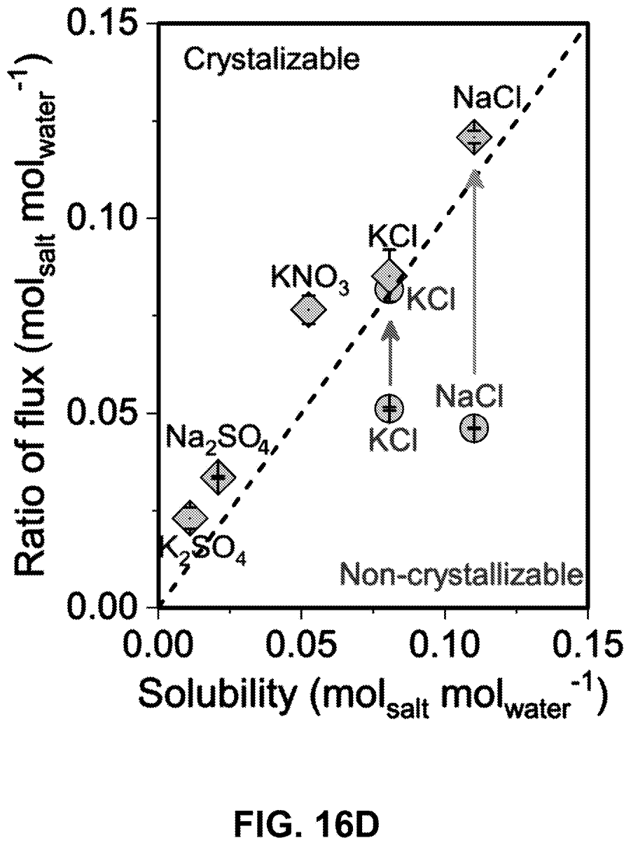

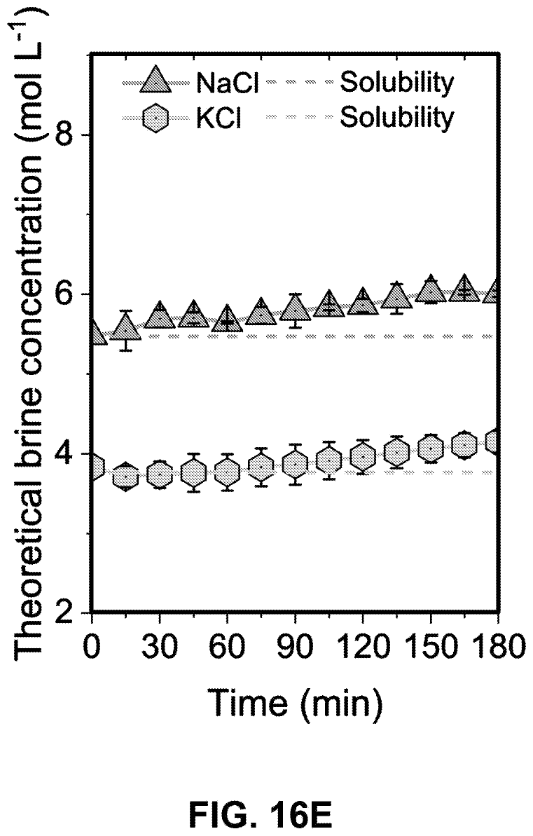

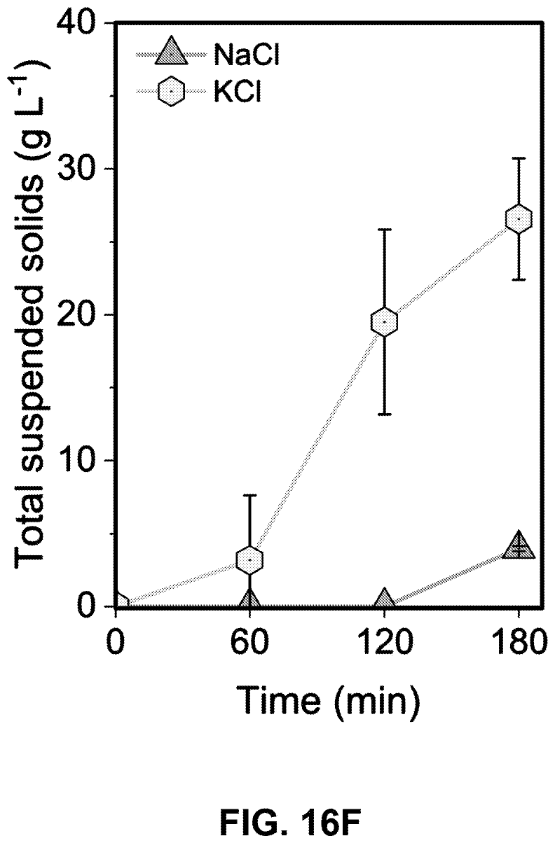

Crystalizability Criterion. In additional to Na₂SO₄, electro-dialytic crystallization has also been tested for other salts such as K₂SO₄, KNO₃, KCl, and NaCl. In all experiments regardless of the crystalizability of the salts, 0.6 M of each salt was used as the feed solution and the saturated solution (at 20° C.) of the corresponding salt as the receiving brine. With same ion exchange membranes (IEMs) used for crystalizing Na₂SO₄, two additional salts, including K₂SO₄ and KNO₃, could be crystalized by electro-dialytic crystallization (FIG. 16A). In all cases, the total suspended solids obtained using batch mode with the same operation time was higher than that obtained using the continuous mode, which was likely caused by the limited crystallization as discussed in previous section. In the case of KNO₃, a “negative total suspended solids” was observed after 60 minutes of operation because the total suspended solids extracted using electro-dialytic crystallization was less than the background total suspended solids obtained with the same system but without applied electrical potential. Because the electric current generates heat in the electrodialysis cell and thus raises the temperature of the flow channels, small nucleates that may have formed in the crystallizer could redissolve in the brine channels of the electrodialysis cell and thus slow down the crystallization rate as compared to that when no current was applied. With longer operation (120 and 180 minutes), the growing degree of oversaturation due to continuous increase of brine concentration eventually outcompeted the effect of re-dissolution of small nucleates in the brine channel and led to the formation of total suspended solids (after subtracting background) in the crystallizer.

Using the same ion exchange membranes and operating conditions, the electro-dialytic crystallization process was unable to produce crystals using feed solutions of KCI and NaCl. The electro-dialytic crystallization process could not precipitate out certain salts because the brine concentrations of these salts did not exceed their solubilities to significant extent, i.e., a sufficient degree of oversaturation was not achieved for the non-crystallizable salts. To illustrate, the total brine concentration was plotted as a function of operation time for the five tested salts and compared to their respective solubilities (FIG. 16B). The total brine concentration is technically the sum of total dissolved solids and total suspended solids of the brine (in molarity). For non-crystallizable salts, the total brine concentration is the total dissolved solids; for crystallizable salts, the total brine concentration can be interpreted as the imaginary total dissolved solids as if crystals never formed. For Na₂SO₄, K₂SO₄, and KNO₃, the total brine concentrations increased consistently throughout the 3-hour electro-dialytic crystallization experiments and exceeded the solubility of the respective salts. For NaCl and KCl, however, the total brine concentration consistently decreased and never exceeded the respective solubilities.

Elucidating the dependence of crystalizability on salt species requires understanding the water and ion transport through ion exchange membrane in an electrodialysis process. There are four major transport phenomena occurring simultaneously in electrodialysis (FIG. 16C): electromigration and diffusion of ions, and electro-osmosis and osmosis of water. The only intended phenomenon in electrodialysis is the electromigration of ions, i.e., the movement of ions under the applied electric field, all other phenomena are “parasitic” and detrimental to the objective of electro-dialytic crystallization. Diffusion of ions from the brine to feed solution occurs due to the presence of concentration gradient (higher salt concentration in the brine). As diffusion rate is proportional to the trans-membrane concentration difference according to Fick's law, (back) diffusion can be significant in electro-dialytic crystallization with a large trans-membrane concentration difference.

Though unintended, water transport also occurs via both osmosis and electro-osmosis. Osmosis results from osmotic pressure difference due to the trans-membrane salt concentration difference. Specifically, the chemical potential of water is lower in the brine with a higher salt concentration than in the feed solution with a lower salt concentration. In addition to osmosis, the ions migrating across ion exchange membranes also “drag” part of the water molecules in their hydration shells, which is referred to as electro-osmosis. Both osmosis and electro-osmosis move water from the feed solution to the brine. Water transport is detrimental to salt crystallization in electro-dialytic crystallization because it increases the brine volume and tends to dilute the brine, which acts against ion electromigration toward enriching the brine beyond solubility.

Considering both the ion and water transport through the ion exchange membranes suggests that the necessary (but not sufficient) condition for crystallization is that the ratio of molar flux between salt and water in an electro-dialytic crystallization process exceeds solubility expressed in molar ratio, Jₛ/J_{w}, where Jₛ and J_{w} are the molar fluxes of the salt and water, respectively. When Jₛ/J_{w} is lower than solubility, the brine can never become saturated even if it starts with a saturated solution. Comparing Jₛ/J_{w} and the solubility for the six salts tested clearly show that the crystallizable salts (Na₂SO₄, K₂SO₄, and KNO₃) satisfied the necessary condition non-crystallizable ones (NaCl, KCl) did not satisfy the necessary condition (FIG. 16D).

While the solubility at a given temperature is an intrinsic property of the salt, Jₛ/J_{w} depends on both salt properties, membrane properties, and operating conditions. It is likely that hydration plays an important role on electro-osmosis. Salts comprising ions that are more strongly hydrated will likely result in more significant electro-osmosis and thus a higher Jₛ/J_{w} with the same ion exchange membranes and operating conditions. When the membrane is made of relatively hydrophobic material, dehydration may occur to shed off some water molecules in the hydrated shell and thereby reduce water transport. Moreover, increasing current density has also been shown as effective in increasing Jₛ/J_{w}.

Following the above principles, additional electro-dialytic crystallization experiments were performed using NaCl and KCl but with a different membrane and operating conditions. These alternative set of ion exchange membranes have significantly lower water uptakes than the reference ion exchange membranes used to collect results for FIG. 16A, which is beneficial to reducing water transport via osmosis and electro-osmosis. The use of the low-water-uptake ion exchange membranes indeed significantly boosted the Jₛ/J_{w}, but this measure alone was still inadequate for crystalizing out KCl and NaCl. Using the low-water-uptake ion exchange membranes with additional measures including (1) applying a higher current density, (2) using a higher feed concentration, and (3) reducing the volume of the brine loop, the brine concentration of KCl and NaCl were eventually pushed beyond their respective solubilities (FIG. 16E) and observed the formation of crystals (FIG. 16F). Higher current density and feed concentration both contributed to a higher Jₛ/J_{w} ratio, whereas a smaller brine volume allowed a fast increase in brine concentration for a given membrane area which in turn promoted the formation of crystal in the relatively short experimental time. In the case of NaCl, only a small total suspended solids was measured toward the end of the 3-hr electro-dialytic crystallization experiments (FIG. 16F), despite the high current density (80 mA cm⁻²) and feed concentration (4 mol L⁻¹). The formation of NaCl crystals seems to require a significant degree of oversaturation (FIG. 16E) and achieving a Jₛ/J_{w} ratio that exceeds solubility did not necessarily result in crystallization (FIG. 16D). Therefore, the criterion of having a higher Jₛ/J_{w} than solubility is only a necessary, but not sufficient, condition for crystal formation.

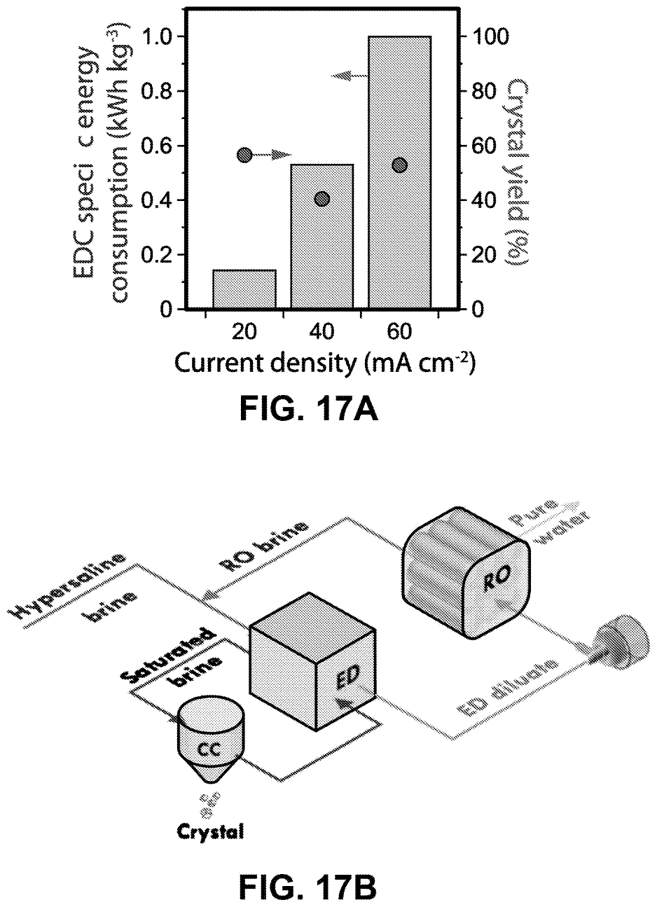

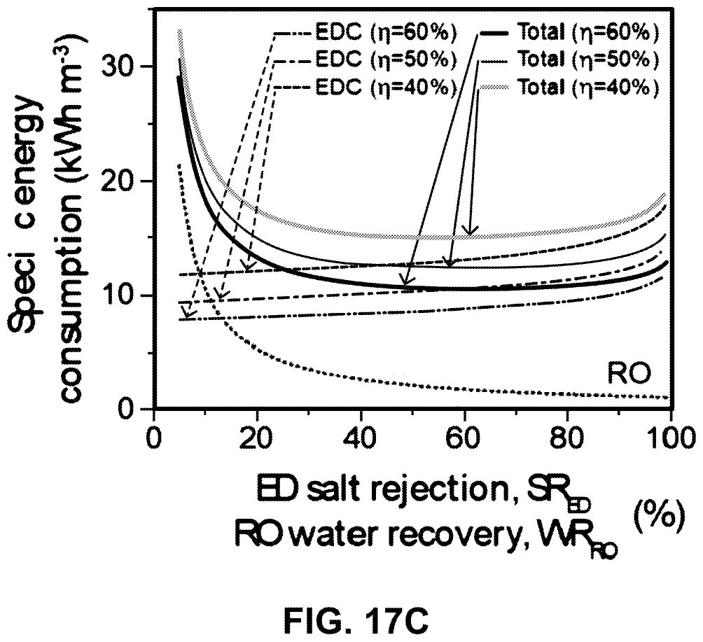

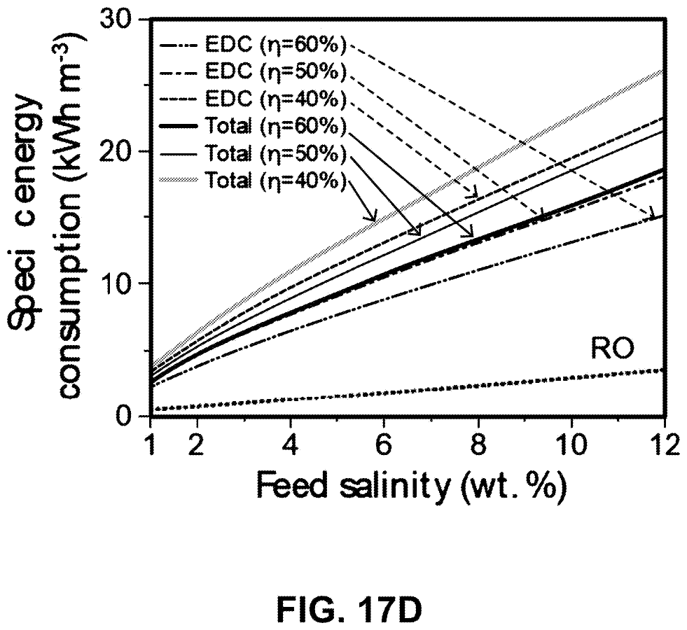

Energy consumption of electro-dialytic crystallization and its integrated zero liquid discharge system. The energy consumptions of electro-dialytic crystallization and the integrated zero liquid discharge treatment train comprising electro-dialytic crystallization and reverse osmosis are estimated using based on experimental data. The current analysis focuses on Na₂SO₄ for which data at different current densities were collected, noting that the results of the analysis can vary significantly depending on salt species, membrane properties, and operating conditions. The crystal-specific energy consumption, i.e., the energy (kWh) consumed to produce a unit mass (kg) of Na₂SO₄ crystal, strongly depends on current density (FIG. 17A), as a higher current density leads to a larger resistive loss. The crystal yield, η, defined as the measured total suspended solids over theoretically maximum total suspended solids calculated using the amount of charge transferred, varies between 40 to 60%. The crystal yield was not unity because (1) not all charge transfer resulted in ion transfer, i.e., current efficiency was lower than unity; and (2) not all salt entering the brine loop can crystalize out due to the parasitic water transport and extra salt required to reach the sufficient level of oversaturation for crystallization. Clearly, n depends on salt species, membrane properties, and operating conditions.

Using an electro-dialytic crystallization process alone to achieve zero liquid discharge (i.e., converting the saline feed stream all the way to fresh water) is both highly inefficient and even infeasible. Instead, an electro-dialytic crystallization process should be coupled with a reverse osmosis process to develop a treatment train for zero liquid discharge (FIG. 17B). In this integrated electro-dialytic crystallization/reverse osmosis treatment train, the electro-dialytic crystallization effluent with a reduced salinity (but still saline) is sent to the reverse osmosis process for producing fresh water, and the reverse osmosis brine mixes with the feed stream to reenter the electro-dialytic crystallization unit. The specific energy consumption (SEC), i.e., energy (kWh) consumed to achieve zero liquid discharge for a unit volume (m³) of feed water, was estimated for such an integrated electro-dialytic crystallization/reverse osmosis zero liquid discharge system using a numerical model.

The analysis reveals that the steady-state operation of electro-dialytic crystallization-reverse osmosis demands that the salt rejection in electrodialysis (SR_{ED}), i.e., that percentage reduction of the total dissolved solids of the electrodialysis feed stream as it flows through the electrodialysis cell, equals exactly the water recovery in the subsequent reverse osmosis process (WR_{RO}). With increasing SR_{ED}, the SEC for the electro-dialytic crystallization unit decreases whereas the SEC for the reverse osmosis unit increases (FIG. 17C). When combined, the SEC of the overall electro-dialytic crystallization-reverse osmosis process, SECₜₒₜ, is a non-monotonic function of SR_{ED}. With very low SR_{ED} (<20%), SECₜₒₜ is very high as reverse osmosis must operate at a very high pressure to desalinate a high salinity brine. When SR_{ED} ranges from 40 to 80%, however, SECₜₒₜ reaches a minimum and is highly insensitive to SR_{ED}. Obviously, the crystal yield, η, strongly affects SEC_{EDC}, which in turn influences SECₜₒₜ.

The analysis was further extended to investigate the impact of feed stream salinity. The analysis shows that SECₜₒₜ monotonically increases with increasing feed salinity (FIG. 17D), as more salt needs to be removed from an electro-dialytic crystallization-reverse osmosis system with a higher feed salinity. Even with a feed salinity of 12 wt. % (the solubility of Na₂SO₄ at 20° C. is ˜16 what %), the SECₜₒₜ ranges from ˜19 to ˜26 kWh m⁻³ depending on the crystal yield. Such an SECₜₒₜ is significantly lower than the typical SEC for a mechanical vapor compression-based brine concentration/crystallization process (30-60 kWh m⁻³). The discrepancy between the SEC for mechanical vapor compression and that for electro-dialytic crystallization-reverse osmosis is even greater with a lower feed salinity, which demonstrates the theoretical potential for electro-dialytic crystallization-reverse osmosis to compete with mechanical vapor compression for achieving zero liquid discharge with Na₂SO₄ brine.

Conclusion and Perspective. It has been demonstrated in this study that electro-dialytic crystallization can crystalize out multiple salts from hypersaline brine using electric field without evaporation. The success of electro-dialytic crystallization for crystallization relies on the ability of promoting ion transport across ion exchange membranes without incurring excessive water transport, so that the brine concentration can exceed the solubility of the salt to be crystallized. Preliminary analysis of the energy consumption for crystallizing Na₂SO₄ using an integrated electro-dialytic crystallization-reverse osmosis system suggests that the electro-dialytic crystallization has the potential to outcompete mechanical vapor compression, the state-of-the-art brine concentration and crystallization technology, for zero liquid discharge applications. Whether electro-dialytic crystallization and its integrated processes can become competitive for zero liquid discharge requires more in-depth and systematic analysis of how the crystalizability and the levelized cost depend on the salt type, operating conditions, and membrane properties. In addition to more systematic parametric studies, further improvement of zero liquid discharge can benefit from the development of low-water-transport ion exchange membranes to minimize parasitic water transport, better understanding of crystallization kinetics and electro-dialytic crystallization behavior with mixed-salt brine and realistic brines that contain fouling agents.

### Example 5

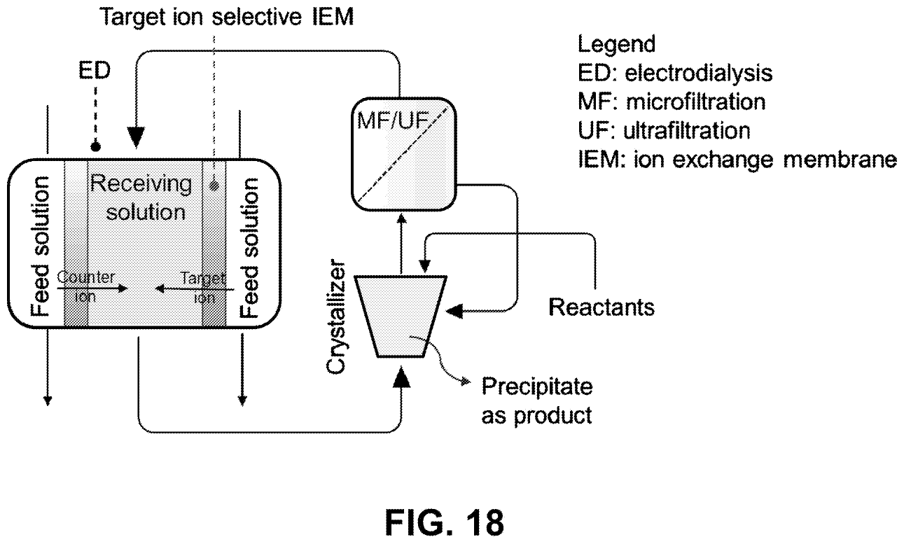

An example system for selective precipitation is shown in FIG. 18, which includes an electrodialysis (ED) cell including a target ion selective ion exchange membrane (IEM), a crystallizer, and a microfiltration (MF) and/or an ultrafiltration (UF) unit.

The ion exchange membrane (IEM) for transporting the target ions has selectivity toward the target ions over the unwanted ions which remain in the feed stream. Reactants can be introduced into the crystallizer which to precipitate the target ion.

For example, the target ion can be lithium, and the reactant can be a hydroxide salt, the product can be lithium hydroxide precipitate (LiOH). Alternatively, the reactant can be a carbonate salt, the product can be lithium carbonate precipitate (Li₂CO₃).

### Exemplary Aspects

In view of the described electro-dialytic crystallizers and methods of use thereof, herein below are described certain more particularly described aspects of the invention. The particularly recited aspects should now, however, be interpreted to have any limiting effect on any different claims containing different or more general teaching described herein or that the “particular” aspects are somehow limited in some wat other than the inherent meaning of the language and formulas literally used herein.

Example 1: An electro-dialytic crystallizer system comprising: an electrodialysis module; and a crystallizer module in liquid communication with the electrodialysis module; wherein the electrodialysis module is configured to receive an aqueous feedwater solution and form a diluate stream and a brine stream, the aqueous feedwater solution comprising an ionic component (e.g., one or more ionic components), the diluate stream having a lower concentration of the ionic component relative to the aqueous feedwater solution, and the brine stream having a higher concentration of the ionic component relative to the aqueous feedwater solution; wherein the electrodialysis module comprises: a feed channel (e.g., one or more feed channels) configured to receive the aqueous feedwater solution; an ion exchange membrane (e.g., one or more ion exchange membranes); a brine channel (e.g., one or more brine channels); and a voltage source; wherein the ion exchange membrane forms a boundary between the feed channel and the brine channel; wherein the ion exchange membrane is in electrochemical and liquid communication with both the feed channel and the brine channel; wherein the voltage source is configured to apply an electric field across the feed channel, ion exchange membrane, and brine channel, such that (when the electric field is applied) the ionic component migrates from the feed channel, across the ion exchange membrane, and into the brine channel, thereby forming the diluate stream in the feed channel and the brine stream in the brine channel; wherein the crystallizer module is configured to receive the brine stream from the brine channel and form crystals comprising the ionic component and a supernatant.

Example 2: The system of any examples herein, particularly example 1, wherein the ion exchange membrane comprises an anion exchange membrane, a cation exchange membrane, or a combination thereof.

Example 3: The system of any examples herein, particularly example 1 or example 2, wherein the ion exchange membrane is selective for a target ion.

Example 4: The system of any examples herein, particularly examples 1-3, wherein the electrodialysis module comprises a first feed channel, a second feed channel, a first ion exchange membrane, and a second exchange membrane, wherein the first exchange membrane forms a boundary between the first feed channel and the brine channel, and the second ion exchange membrane forms a boundary between the second feed channel and the brine channel.

Example 5: The system of any examples herein, particularly example 4, wherein the first ion exchange membrane is a cation exchange membrane and/or the second ion exchange membrane is an anion exchange membrane.

Example 6: The system of any examples herein, particularly examples 1-5, wherein the electrodialysis module comprises a first feed channel, a second feed channel, a first brine channel, a second brine channel, a first ion exchange membrane, a second exchange membrane, and a third ion exchange membrane, wherein the first exchange membrane forms a boundary between the first feed channel and the first brine channel, the second ion exchange membrane forms a boundary between the second feed channel and the first brine channel, and the third ion exchange membrane forms a boundary between the second feed channel and the second brine channel.

Example 7: The system of any examples herein, particularly examples 1-6, wherein the system further comprises a filtration module in liquid communication with the crystallizer module, wherein the filtration module is configured to separate the crystals from the supernatant.

Example 8: The system of any examples herein, particularly example 7, wherein the filtration module is further in liquid communication with the electrodialysis module.

Example 9: The system of any examples herein, particularly examples 1-8, wherein the brine channel is further configured to receive the supernatant from the crystallizer module and/or the filtration module.

Example 10: The system of any examples herein, particularly examples 1-9, wherein the crystallizer module is further configured to receive a reactant, for example that reacts (e.g., with the target ion) to form crystals within the crystallizer module.

Example 11: The system of any examples herein, particularly examples 1-9, further comprising a reverse osmosis module in liquid communication with the electrodialysis module, wherein the reverse osmosis module is configured to receive the diluate stream from the feed channel and subject the diluate stream to reverse osmosis to form a water stream and an effluent stream.

Example 12: The system of any examples herein, particularly example 11, further comprising a collection container in liquid communication with the reverse osmosis module, the collection container being configured to receive and store the water stream from the reverse osmosis module.

Example 13: The system of any examples herein, particularly example 11 or example 12, wherein the feed channel is further configured to receive the effluent stream from the reverse osmosis module.

Example 14: The system of any examples herein, particularly examples 1-13, wherein the ionic component comprises a salt, an electrolyte, or a combination thereof.

Example 15: The system of any examples herein, particularly examples 1-14, wherein the ionic component comprises an alkali metal salt, a sulfate, a nitrate, a halide, or a combination thereof.

Example 16: The system of any examples herein, particularly examples 1-15, wherein the ionic component comprises a potassium salt, a sodium salt, a sulfate, a nitrate, a chloride, or a combination thereof.

Example 17: The system of any examples herein, particularly examples 1-16, wherein the ionic component comprises Na₂SO₄, K₂SO₄, KNO₃, NaCl, KCl, or a combination thereof.

Example 18: The system of any examples herein, particularly examples 1-17, wherein the ionic component comprises Na₂SO₄, K₂SO₄, KNO₃, or a combination thereof.

Example 19: The system of any examples herein, particularly examples 1-18, wherein the system is a zero liquid discharge system.

Example 20: The system of any examples herein, particularly examples 1-19, wherein the aqueous feedwater solution comprises a salt solution, produced water (e.g., from mining, fracking, oil recovery), brine, or a combination thereof.

Example 21: The system of any examples herein, particularly examples 1-20, wherein the aqueous feedwater solution comprises brine resulting from the power industry, chemical industry, food industry, oil and gas industry (e.g., hydraulic fracturing), desalination industry (e.g., inland brackish water desalination), mining industry, or a combination thereof.

Example 22: The system of any examples herein, particularly examples 1-21, wherein the aqueous feedwater solution has a total dissolved solids content of from greater than 0 g/L to 250 g/L

Example 23: The system of any examples herein, particularly examples 1-22, wherein the aqueous feedwater solution has a total dissolved solids content of 30 g/L or more, 50 g/L or more, 75 g/L or more, 100 g/L or more, or 200 g/L or more.

Example 24: The system of any examples herein, particularly examples 1-23, wherein the total dissolved solids of the diluate stream is less than that of the aqueous feedwater solution.

Example 25: The system of any examples herein, particularly examples 1-24, wherein the total dissolved solids of brine stream is greater than that of the aqueous feedwater solution.

Example 26: The system of any examples herein, particularly examples 11-25, wherein the water stream is substantially free of dissolved solids (e.g., has a total dissolved solids content if substantially 0).

Example 27: A method of use of the system of any examples herein, particularly examples 1-26, the method comprising using the system to treat the aqueous feedwater solution.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The devices and methods of the appended claims are not limited in scope by the specific devices and methods described herein, which are intended as illustrations of a few aspects of the claims and any devices and methods that are functionally equivalent are intended to fall within the scope of the claims. Various modifications of the devices and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. An electro-dialytic crystallizer system comprising:
an electrodialysis module; and
a crystallizer module in liquid communication with the electrodialysis module;
wherein the electrodialysis module is configured to receive an aqueous feedwater solution and form a diluate stream and a brine stream, the aqueous feedwater solution comprising an ionic component, the diluate stream having a lower concentration of the ionic component relative to the aqueous feedwater solution, and the brine stream having a higher concentration of the ionic component relative to the aqueous feedwater solution;
wherein the electrodialysis module comprises:
a feed channel configured to receive the aqueous feedwater solution;
an ion exchange membrane;
a brine channel; and
a voltage source;
wherein the ion exchange membrane forms a boundary between the feed channel and the brine channel;
wherein the ion exchange membrane is in electrochemical and liquid communication with both the feed channel and the brine channel;
wherein the voltage source is configured to apply an electric field across the feed channel, ion exchange membrane, and brine channel, such that (when the electric field is applied) the ionic component migrates from the feed channel, across the ion exchange membrane, and into the brine channel, thereby forming the diluate stream in the feed channel and the brine stream in the brine channel;
wherein the crystallizer module is configured to receive the brine stream from the brine channel and form crystals comprising the ionic component and a supernatant;
wherein the ion exchange membrane comprises an anion exchange membrane, a cation exchange membrane, or a combination thereof; and
wherein the ion exchange membrane is selective for a target ion.

2. (canceled)

3. (canceled)

4. The system of claim 1, wherein the electrodialysis module comprises a first feed channel, a second feed channel, a first ion exchange membrane, and a second exchange membrane, wherein the first exchange membrane forms a boundary between the first feed channel and the brine channel, and the second ion exchange membrane forms a boundary between the second feed channel and the brine channel.

5. The system of claim 4, wherein the first ion exchange membrane is a cation exchange membrane and/or the second ion exchange membrane is an anion exchange membrane.

6. The system of claim 1, wherein the electrodialysis module comprises a first feed channel, a second feed channel, a first brine channel, a second brine channel, a first ion exchange membrane, a second exchange membrane, and a third ion exchange membrane, wherein the first exchange membrane forms a boundary between the first feed channel and the first brine channel, the second ion exchange membrane forms a boundary between the second feed channel and the first brine channel, and the third ion exchange membrane forms a boundary between the second feed channel and the second brine channel.

7. The system of claim 1, wherein the system further comprises a filtration module in liquid communication with the crystallizer module, wherein the filtration module is configured to separate the crystals from the supernatant.

8. The system of claim 7, wherein the filtration module is further in liquid communication with the electrodialysis module.

9. The system of claim 7, wherein the brine channel is further configured to receive the supernatant from the crystallizer module and/or the filtration module.

10. The system of claim 1, wherein the crystallizer module is further configured to receive a reactant that reacts with the target ion to form crystals within the crystallizer module.

11. The system of claim 1, further comprising a reverse osmosis module in liquid communication with the electrodialysis module, wherein the reverse osmosis module is configured to receive the diluate stream from the feed channel and subject the diluate stream to reverse osmosis to form a water stream and an effluent stream.

12. The system of claim 11, further comprising a collection container in liquid communication with the reverse osmosis module, the collection container being configured to receive and store the water stream from the reverse osmosis module.

13. The system of claim 11, wherein the feed channel is further configured to receive the effluent stream from the reverse osmosis module.

14. The system of claim 1, wherein the ionic component comprises a salt, an electrolyte, or a combination thereof.

15. The system of claim 1, wherein the ionic component comprises an alkali metal salt, a sulfate, a nitrate, a halide, or a combination thereof.

16. The system of claim 1, wherein the ionic component comprises a potassium salt, a sodium salt, a sulfate, a nitrate, a chloride, or a combination thereof.

17. (canceled)

18. (canceled)

19. The system of claim 1, wherein the system is a zero liquid discharge system.

20. The system of claim 1, wherein the aqueous feedwater solution comprises a salt solution, produced water, brine, or a combination thereof.

21. The system of claim 1, wherein the aqueous feedwater solution comprises brine resulting from the power industry, chemical industry, food industry, oil and gas industry, desalination industry, mining industry, or a combination thereof.

22. The system of claim 1, wherein the aqueous feedwater solution has a total dissolved solids content of from greater than 0 g/L to 250 g/L.

23. (canceled)

24. The system of claim 1, wherein the total dissolved solids of the diluate stream is less than that of the aqueous feedwater solution, wherein the total dissolved solids of brine stream is greater than that of the aqueous feedwater solution, or a combination thereof.

25. (canceled)

26. (canceled)

27. A method of use of the system of claim 1, the method comprising using the system to treat the aqueous feedwater solution.
